(19) United States
(12) Patent Application Publication
(10) Pub. No.: US 2023/0365737 A1
(43) Pub. Date: Nov. 16, 2023

(54) ISO(THIO)CYANATE COMPOUND, POLYMERIZABLE COMPOSITION FOR OPTICAL MATERIAL, MOLDED BODY, OPTICAL MATERIAL, PLASTIC LENS, PLASTIC POLARIZING LENS, METHOD FOR PRODUCING ISO(THIO)CYANATE COMPOUND, METHOD FOR PRODUCING POLYMERIZABLE COMPOSITION FOR OPTICAL MATERIAL, METHOD FOR PRODUCING OPTICAL MATERIAL, AND METHOD FOR PRODUCING PLASTIC POLARIZING LENS

(71) Applicant: MITSUI CHEMICALS, INC., Minato-ku, Tokyo (JP)

(72) Inventors: Takayuki HANAWA, Omuta-shi, Fukuoka (JP); Akinori RYU, Arao-shi, Kumamoto (JP)

(73) Assignee: MITSUI CHEMICALS, INC., Minato-ku, Tokyo (JP)

(21) Appl. No.: 18/245,014

(22) PCT Filed: Dec. 24, 2021
(86) PCT No.: PCT/JP2021/048390

§ 371 Date: Mar. 13, 2023

(30) Foreign Application Priority Data
Dec. 25, 2020 (JP) 2020-216938
Feb. 5, 2021 (JP) 2021-017452
Feb. 5, 2021 (JP) 2021-017453

(51) Int. Cl. C08G 18/38; C08G 18/10; C08G 18/24; C08G 18/20; C08G 18/66; C08K 5/3475; G02B 1/04

(52) U.S. Cl. CPC C08G 18/3859; C08G 18/10; C08G 18/242; C08G 18/2072; C08G 18/66; C08K 5/3475; G02B 1/041; B29C 2045/0075

(57) ABSTRACT

An iso(thio)cyanate compound that is a reaction product between an amine compound (A) including at least one selected from a compound (a1) represented by general formula (1) or a compound (a2) represented by general formula (2) and a bi- or higher-functional iso(thio)cyanate compound (B), the iso(thio)cyanate compound having a value of Mw/Mn of 1.31 or less, the value of Mw/Mn being a weight average molecular weight (Mw) divided by a number average molecular weight (Mn).

### TECHNICAL FIELD

The disclosure relates to an iso(thio)cyanate compound, a polymerizable composition for an optical material, a molded body, an optical material, a plastic lens, a plastic polarizing lens, a method for producing an iso(thio)cyanate compound, a method for producing a polymerizable composition for an optical material, a method for producing an optical material, and a method for producing a plastic polarizing lens.

### BACKGROUND ART

Currently, optical materials for use in various applications have been developed.

The optical material is, for example, a plastic lens.

Plastic lenses are lighter in weight than inorganic lenses, are less likely to break, and can be dyed. Therefore, in recent years, plastic lenses have rapidly become widespread as optical materials for spectacle lenses, camera lenses, and the like.

A material used as an optical material has been mainly glass since a long time ago, but, in recent years, various plastics for optical materials have been developed and widely used as substitutes for glass. As materials for spectacle lenses and the like, plastic materials such as acrylic resins, aliphatic carbonate resins, polycarbonates, and polythiourethanes have come to be mainly used because they have excellent optical properties, are light in weight, are not broken, and are excellent in moldability.

In recent years, due to a change in life style, people who enjoy doing physical exercise such as sports while wearing sunglasses are increasing. In addition, with an increase in safety awareness, there is a growing demand for spectacles for children to be less likely to break. Under such circumstances, there is an increasing demand for a substrate that is lighter in weight and has good impact resistance. In response to these increasing demands, a urethane urea resin has been developed for spectacle lens applications as a substrate having good impact resistance.

For example, Patent Document 1 describes a polymerizable composition for an optical material, containing (A) at least one amine compound selected from a compound (a1) represented by general formula (1) and a compound (a2) represented by general formula (2), (B) an iso(thio)cyanate compound having two or more iso(thio)cyanato groups, and (C) a polythiol compound containing a dithiol compound (c1) having two mercapto groups and a polythiol compound (c2) having three or more mercapto groups.
Patent Document 1: WO 2018/079518

### SUMMARY OF INVENTION

### Technical Problem

When an optical material is produced, a polymerizable composition is often used.

The polymerizable composition can be cured by a polymerization reaction to obtain an optical material.

In the optical material obtained using the polymerizable composition, turbidity (also referred to as haze) may occur.

The occurrence of turbidity in the optical material is one of causes for lowering the quality of the optical material, and thus improvement is required.

The optical material of Patent Document 1 has room for improvement in suppressing the occurrence of turbidity.

A problem to be solved by one aspect of the disclosure is to provide an iso(thio)cyanate compound capable of providing a cured product with good impact resistance and suppressed turbidity, and a polymerizable composition for an optical material containing the iso(thio)cyanate compound.

### Solution to Problem

Means for solving the problem include the following aspects.

<1> An iso(thio)cyanate compound that is a reaction product between an amine compound (A) including at least one selected from a compound (a1) represented by the following general formula (1) or a compound (a2) represented by the following general formula (2) and a bi- or higher-functional iso(thio)cyanate compound (B), the iso(thio)cyanate compound having a value of Mw/Mn of 1.31 or less, the value of Mw/Mn being a weight average molecular weight (Mw) divided by a number average molecular weight (Mn).

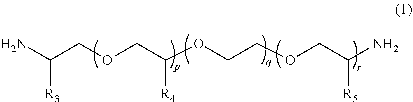

In general formula (1), each of R₃ to R₅ independently represents a hydrogen atom or a methyl group. p represents an integer from 0 to 100; q represents an integer from 0 to 100; r represents an integer from 0 to 100; and p+r equals an integer from 1 to 100. When a plurality of R₄ is present, respective R₄'s may be the same as or different from each other. When a plurality of R₅ is present, respective R₅'s may be the same as or different from each other.

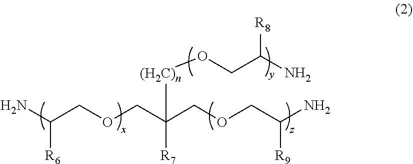

In general formula (2), each of R₆, R₈ and R₉ independently represents a hydrogen atom or a methyl group. R₇ represents a linear alkyl group having 1 to 20 carbon atoms, a branched alkyl group having 3 to 20 carbon atoms, or a cyclic alkyl group having 3 to 20 carbon atoms. x represents an integer from 0 to 200; y represents an integer from 0 to 200; z represents an integer from 0 to 200; and x+y+z equals an integer from 1 to 200. n represents an integer from 0 to 10. When a plurality of R₆ is present, respective R₆'s may be the same as or different from each other. When a plurality of R₈ is present, respective R₈'s may be the same as or different from each other. When a plurality of R₉ is present, respective R₉'s may be the same as or different from each other.

<2> The iso(thio)cyanate compound according to <1>, wherein a ratio (a/b) of a number of moles a of an amino group in the amine compound (A) to a number of moles b of an iso(thio)cyanato group in the iso(thio)cyanate compound (B) is less than 1.0.

<3> The iso(thio)cyanate compound according to <1> or <2>, wherein the amine compound (A) includes the compound (a1) represented by the general formula (1), and a weight average molecular weight (Mw) of the compound (a1) represented by the general formula (1) is from 100 to 4000.

<4> The iso(thio)cyanate compound according to any one of <1> to <3>, wherein the amine compound (A) includes the compound (a2) represented by the general formula (2), and a weight average molecular weight (Mw) of the compound (a2) represented by the general formula (2) is from 100 to 5000.

<5> The iso(thio)cyanate compound according to any one of <1> to <4>, wherein the iso(thio)cyanate compound (B) is at least one selected from the group consisting of hexamethylene diisocyanate, pentamethylene diisocyanate, xylylene diisocyanate, isophorone diisocyanate, bis(isocyanatomethyl)cyclohexane, dicyclohexylmethane-4,4′-diisocyanate, 2,5-bis(isocyanatomethyl)bicyclo-[2.2.1]-heptane, 2,6-bis(isocyanatomethyl)bicyclo-[2.2.1]-heptane, tolylene diisocyanate, phenylene diisocyanate, and 4,4′-diphenylmethane diisocyanate.

<6> A polymerizable composition for an optical material, the polymerizable composition containing the iso(thio)cyanate compound according to any one of <1> to <5>.

<7> The polymerizable composition for an optical material according to <6>, further containing the iso(thio)cyanate compound (B).

<8> The polymerizable composition for an optical material according to <6> or <7>, further containing a thiol compound (C) including at least one of a dithiol compound (c1) having two mercapto groups or a polythiol compound (c2) having three or more mercapto groups.

<9> The polymerizable composition for an optical material according to <8>, wherein the thiol compound (C) includes both the dithiol compound (c1) and the polythiol compound (c2), and a ratio (c1/c2) of a number of moles c1 of the mercapto groups of the dithiol compound (c1) to a number of moles c2 of the mercapto groups in the polythiol compound (c2) is in a range of from 1 to 13.

<10> The polymerizable composition for an optical material according to <8> or <9>, wherein:
the dithiol compound (c1) is at least one selected from the group consisting of 2,5-dimercaptomethyl-1,4-dithiane, ethylene glycol bis(3-mercaptopropionate), 4,6-bis(mercaptomethylthio)-1,3-dithiane, 2-(2,2-bis(mercaptomethylthio)ethyl)-1,3-dithietane, and bis(2-mercaptoethyl)sulfide, and
the polythiol compound (c2) is at least one selected from the group consisting of trimethylolpropane tris(3-mercaptopropionate), pentaerythritol tetrakis(2-mercaptoacetate), pentaerythritol tetrakis(3-mercaptopropionate), 4-mercaptomethyl-1,8-dimercapto-3,6-dithiaoctane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, and 1,1,3,3-tetrakis(mercaptomethylthio)propane.

<11> The polymerizable composition for an optical material according to any one of <6> to <10>, further containing an organotin compound (D) and a tertiary amine compound (E).

<12> The polymerizable composition for an optical material according to any one of <6> to <11>, further containing an ultraviolet absorber (F) having a maximum absorption peak in a range of from 350 nm to 370 nm and including a compound represented by the following general formula (6).

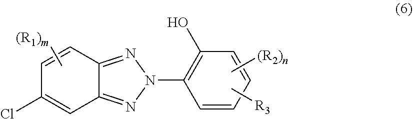

In general formula (6), each of R₁ and R₂ independently represents an alkyl group having 1 to 8 carbon atoms. When a plurality of R₁ is present, respective R₁'s may be the same as or different from each other. When a plurality of R₂ is present, respective R₂'s may be the same as or different from each other. R₃ represents a functional group having 2 to 15 carbon atoms and containing an ester bond. m represents an integer from 0 to 3; and n represents an integer from 0 to 3.

<13> A molded body, obtained by curing the polymerizable composition for an optical material according to any one of <6> to <12>.

<14> An optical material, including the molded body according to <13>.

<15> A plastic lens, including the molded body according to <13>.

<16> A plastic polarizing lens, including: a substrate layer including the molded body according to <13>; and a polarizing film.

<17> An iso(thio)cyanate compound production method for producing the iso(thio)cyanate compound according to any one of <1> to <5>, the method including:
a step of producing the iso(thio)cyanate compound by reacting the amine compound (A) with the iso(thio)cyanate compound (B) under a condition that satisfies at least one of the following condition 1 or condition 2:

Condition 1: a mixture of the amine compound (A) and the iso(thio)cyanate compound (B) is reacted by stirring at a stirring rate of 150 rpm to 200 rpm, and the amine compound (A) and the iso(thio)cyanate compound (B) are reacted in a reaction device in which a ratio (D/d) of a reactor diameter (D) to a stirring blade diameter (d) is 3.0 or less,

Condition 2: a mixture of the amine compound (A) and the iso(thio)cyanate compound (B) is reacted by stirring at a stirring rate of 200 rpm or more.

<18> A method for producing a polymerizable composition for an optical material, the method including: a step of producing an iso(thio)cyanate compound by the iso(thio)cyanate compound production method according to <17>; and a step of mixing the iso(thio)cyanate compound with a thiol compound (C) including at least one of a dithiol compound (c1) having two mercapto groups or a polythiol compound (c2) having three or more mercapto groups to produce a composition.

<19> A method for producing an optical material, the method including: a step of injecting the polymerizable composition for an optical material according to any one of <6> to <12> into a mold; and a step of polymerizing and curing the polymerizable composition for an optical material in the mold.

<20> A method for producing a plastic polarizing lens, the method including: a step of disposing a polarizing film in a mold; a step of injecting the polymerizable composition for an optical material according to any one of <6> to <12> into the mold in which the polarizing film is disposed; and a step of polymerizing and curing the polymerizable composition for an optical material to obtain a plastic polarizing lens including: a substrate layer including a molded body obtained by curing the polymerizable composition for an optical material; and a polarizing film.

### Advantageous Effects of Invention

One aspect of the disclosure can provide an iso(thio)cyanate compound capable of providing a cured product with good impact resistance and suppressed turbidity, and a polymerizable composition for an optical material containing the iso(thio)cyanate compound.

### DESCRIPTION OF EMBODIMENTS

In the disclosure, a numerical range indicated using “to” means a range including numerical values described before and after “to” as a lower limit value and an upper limit value.

In the disclosure, the term “step” includes not only an independent step but also a step that cannot be clearly distinguished from other steps as long as the intended purpose of step is achieved.

In the disclosure, if there are a plurality of substances corresponding to each of components in a composition, the amount of each component contained in the composition means a total amount of the plurality of substances present in the composition unless otherwise specified.

In the numerical ranges described in stages in the disclosure, the upper limit value or the lower limit value described in one numerical range may be replaced with the upper limit value or the lower limit value of any other numerical range described in stages. In addition, in the numerical ranges described in the disclosure, the upper limit values or the lower limit values of the numerical ranges may be replaced with values shown in Examples.

In the disclosure, the term “iso(thio)cyanate” means isocyanate or isothiocyanate.

The disclosure includes a first embodiment, a second embodiment, and a third embodiment.

Hereinafter, the first embodiment, the second embodiment, and the third embodiment will be described in detail.

### First Embodiment

<<Iso(thio)cyanate Compound>>

An iso(thio)cyanate compound of the first embodiment is a reaction product between an amine compound (A) including at least one selected from a compound (a1) represented by the following general formula (1) or a compound (a2) represented by the following general formula (2) and a bi- or higher-functional iso(thio)cyanate compound (B), and has a value of Mw/Mn of 1.31 or less, the value of Mw/Mn being a weight average molecular weight (Mw) divided by a number average molecular weight (Mn).

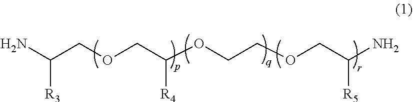

In general formula (1), each of R₃ to R₅ independently represents a hydrogen atom or a methyl group. p represents an integer from 0 to 100; q represents an integer from 0 to 100; r represents an integer from 0 to 100; and p+r equals an integer from 1 to 100. When a plurality of R₄ is present, respective R₄'s may be the same as or different from each other. When a plurality of R₅ is present, respective R₅'s may be the same as or different from each other.

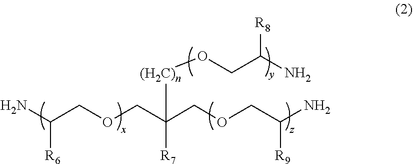

In general formula (2), each of R₆, R₈ and R₉ independently represents a hydrogen atom or a methyl group. R₇ represents a linear alkyl group having 1 to 20 carbon atoms, a branched alkyl group having 3 to 20 carbon atoms, or a cyclic alkyl group having 3 to 20 carbon atoms. x represents an integer from 0 to 200; y represents an integer from 0 to 200; z represents an integer from 0 to 200; and x+y+z equals an integer from 1 to 200. n represents an integer from 0 to 10. When a plurality of R₆ is present, respective R₆'s may be the same as or different from each other. When a plurality of R₈ is present, respective R₈'s may be the same as or different from each other. When a plurality of R₉ is present, respective R₉'s may be the same as or different from each other.

By combining the feature that the iso(thio)cyanate compound of the first embodiment is a reaction product between the amine compound (A) having a specific structure and the bi- or higher-functional iso(thio)cyanate compound (B) and the feature that the value of Mw/Mn is 1.31 or less, a cured product having good impact resistance and suppressed turbidity can be obtained.

The composition for an optical material containing the iso(thio)cyanate compound of the first embodiment can suppress the turbidity of the resulting cured product.

<Mw/Mn>

The iso(thio)cyanate compound of the first embodiment has a value of Mw/Mn, which is the weight average molecular weight (Mw) divided by the number average molecular weight (Mn), of 1.31 or less.

The iso(thio)cyanate compound of the first embodiment has a value of Mw/Mn within the above range, so that a cured product having good impact resistance and suppressed turbidity can be obtained.

From the above viewpoint, the iso(thio)cyanate compound of the first embodiment has a value of Mw/Mn of preferably 1.22 or less, more preferably 1.17 or less.

The value of Mw/Mn is measured by the following GPC measurement method using a gel permeation chromatograph (GPC).

### —GPC Measurement Device—

Alliance (registered trademark) and 2414 type differential refraction detector manufactured by Waters Corporation, or LC-2030C LT PLUS and differential refractive index detector RID-20A manufactured by Shimadzu Corporation

—Column—
Agilent Technologies, Plgel 5 m Mixed-C (300×7.5 mm) (3 columns)

—Preparation of Sample—

A sample (0.05 g) is weighed, and 2 mL of methanol (super dehydrated) is added to dissolve the sample. After leaving at room temperature for 3 days, methanol is removed by nitrogen purge. Thereafter, the sample is dissolved in THE to prepare a sample solution having a concentration of 1.0 wt %.

—Measurement Condition—

The sample solution (0.1 mL) is dissolved in a solvent (THF), and introduced into the column at a temperature of 40° C. and a flow rate of 1 mL/min.

The sample concentration in the sample solution separated by the column is measured with a differential refractometer. A calibration curve is created with a polystyrene standard sample, and the weight average molecular weight (Mw) and value of Mw/Mn of the iso(thio)cyanate compound of the first embodiment are calculated based on the created calibration curve.

In the first embodiment, the weight average molecular weight (Mw) and value of Mw/Mn of the iso(thio)cyanate compound refer to a value of Mw/Mn of the iso(thio)cyanate compound as the reaction product, and are calculated excluding an unreacted iso(thio)cyanate compound (B).

The sample solution contains the iso(thio)cyanate compound of the first embodiment that is a reaction product between the amine compound (A) including at least one selected from the compound (a1) represented by general formula (1) or the compound (a2) represented by the following general formula (2) and the bi- or higher-functional iso(thio)cyanate compound (B), and may further contain an unreacted amine compound (A) and an unreacted iso(thio)cyanate compound (B).

That is, in a chromatogram obtained at the time of measurement with the differential refractometer, in addition to a peak of the iso(thio)cyanate compound of the first embodiment that is a reaction product, peaks of the amine compound (A), the iso(thio)cyanate compound (B), and the like may also be shown.

The weight average molecular weight (Mw) and value of Mw/Mn of the iso(thio)cyanate compound of the first embodiment are calculated using, among the peaks described above, the peak of the iso(thio)cyanate compound of the first embodiment that is a reaction product.

The peak of the iso(thio)cyanate compound of the first embodiment that is a reaction product is a peak on the polymer side relative to the peaks of the amine compound (A) and the iso(thio)cyanate compound (B).

[Amine Compound (A)]

The amine compound (A) used in the polymerizable composition for an optical material of the first embodiment includes at least one selected from the compound (a1) represented by general formula (1) or the compound (a2) represented by general formula (2).

(Compound (a1))

The amine compound (A) may contain the compound (a1) represented by the following general formula (1).

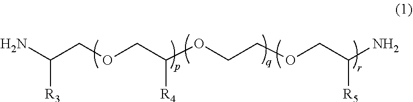

In general formula (1), each of R₃ to R₅ independently represents a hydrogen atom or a methyl group. p represents an integer from 0 to 100; q represents an integer from 0 to 100; r represents an integer from 0 to 100; and p+r equals an integer from 1 to 100. When a plurality of R₄ is present, respective R₄'s may be the same as or different from each other. When a plurality of R₅ is present, respective R₅'s may be the same as or different from each other.

In general formula (1), p is an integer from 0 to 100, preferably an integer from 0 to 70, and more preferably an integer from 0 to 35.
q is an integer from 0 to 100, preferably an integer from 0 to 70, and more preferably an integer from 0 to 40.
r is an integer from 0 to 100, preferably an integer from 0 to 70, and more preferably an integer from 0 to 35.
p+r equals an integer from 1 to 100, preferably an integer from 1 to 70, and more preferably an integer from 1 to 35.

When the amine compound (A) includes the compound (a1) represented by general formula (1), the weight average molecular weight (Mw) of the compound (a1) represented by general formula (1) is preferably from 100 to 4000, more preferably from 200 to 4000, still more preferably from 400 to 2000, and particularly preferably from 500 to 2000.

The compound (a1) having a weight average molecular weight in the above range has mild reactivity to iso(thio)cyanate, and, as a result, a uniform iso(thio)cyanate compound can be obtained.

Examples of the compound represented by general formula (1) can include HK-511, ED-600, ED-900, ED-2003, D-230, D-400, D-2000, and D-4000 (trade names, manufactured by HUNTSMAN), but are not limited only to these exemplary compounds. These compounds may be used alone or as a mixture of two or more thereof.

In the first embodiment, from the viewpoint of the effect in the first embodiment, a compound represented by the following general formula (1a) in which both p and q are 0 can be preferably used as the compound (a1).

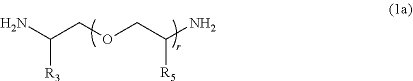

In general formula (1a), R₃, R₅ and r have the same meanings as R₃, R₅ and r in general formula (1), respectively.

(Compound (a2))

The amine compound (A) may contain the compound (a2) represented by the following general formula (2).

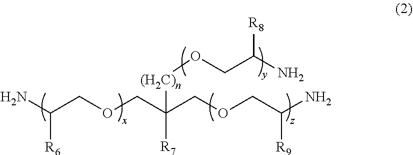

In general formula (2), each of R₆, R₈ and R₉ independently represents a hydrogen atom or a methyl group. R₇ represents a linear alkyl group having 1 to 20 carbon atoms, a branched alkyl group having 3 to 20 carbon atoms, or a cyclic alkyl group having 3 to 20 carbon atoms. x represents an integer from 0 to 200; y represents an integer from 0 to 200; z represents an integer from 0 to 200; and x+y+z equals an integer from 1 to 200. n represents an integer from 0 to 10. When a plurality of R₆ is present, respective R₆'s may be the same as or different from each other. When a plurality of R₈ is present, respective R₈'s may be the same as or different from each other. When a plurality of R₉ is present, respective R₉'s may be the same as or different from each other.

In the first embodiment, as the compound represented by general formula (2), x+y+z is an integer from 1 to 200, preferably an integer from 1 to 100, and more preferably an integer from 1 to 50.
n is an integer from 0 to 10, preferably an integer from 0 to 5, and more preferably 0 or 1.

When the amine compound (A) includes the compound (a2) represented by general formula (2), the weight average molecular weight (Mw) of the compound represented by general formula (2) is preferably from 100 to 5000, more preferably from 400 to 5000, still more preferably from 400 to 3000, and particularly preferably from 500 to 2000.

The compound (a2) having a weight average molecular weight in the above range has mild reactivity to iso(thio)cyanate, and, as a result, a uniform iso(thio)cyanate compound can be obtained.

Examples of the linear alkyl group having 1 to 20 carbon atoms represented as R₇ include a methyl group, an ethyl group, a n-propyl group, a n-butyl group, a pentyl group, a hexyl group, a heptyl group, a n-octyl group, a nonyl group, a decyl group, and a dodecyl group; examples of the branched alkyl group having 3 to 20 carbon atoms include an isopropyl group, an isobutyl group, a t-butyl group, an isopentyl group, an isooctyl group, a 2-ethylhexyl group, a 2-propylpentyl group, and an isodecyl group; and examples of the cyclic alkyl group having 3 to 20 carbon atoms include a cyclopropyl group, a cyclobutyl group, a cyclopentyl group, a cyclohexyl group, a cycloheptyl group, and a cyclooctyl group.

Examples of the compound represented by general formula (2) include T-403, T-3000 (XTJ-509), and T-5000 (trade names, manufactured by HUNTSMAN), but are not limited only to these exemplary compounds. These compounds may be used alone or as a mixture of two or more thereof.

The amine compound (A) may be one amine compound or may contain a plurality of amine compounds.

When the amine compound (A) includes a plurality of amine compounds, for example, the strength of a hard multi-coated product can be improved.

[Iso(thio)cyanate Compound (B)]

The iso(thio)cyanate compound (B) used in the polymerizable composition for an optical material of the first embodiment is a bi- or higher-functional iso(thio)cyanate compound.

Examples of the iso(thio)cyanate compound (B) can include aliphatic polyisocyanate compounds, alicyclic polyisocyanate compounds, aromatic polyisocyanate compounds, heterocyclic polyisocyanate compounds, aliphatic polyisothiocyanate compounds, alicyclic polyisothiocyanate compounds, aromatic polyisothiocyanate compounds, and sulfur-containing heterocyclic polyisothiocyanate compounds, and modified products thereof.

More specific examples of the isocyanate compound include aliphatic polyisocyanate compounds such as pentamethylene diisocyanate, hexamethylene diisocyanate, 2,2,4-trimethylhexane diisocyanate, 2,4,4-trimethylhexamethylene diisocyanate, lysine diisocyanatomethyl ester, lysine triisocyanate, xylylene diisocyanate, p-xylene diisocyanate, α,α,α′,α′-tetramethylxylylene diisocyanate, bis(isocyanatomethyl)naphthalene, mesitylene triisocyanate, bis(isocyanatomethyl)sulfide, bis(isocyanatoethyl)sulfide, bis(isocyanatomethyl)disulfide, bis(isocyanatoethyl)disulfide, bis(isocyanatomethylthio)methane, bis(isocyanatoethylthio)methane, bis(isocyanatoethylthio)ethane, and bis(isocyanatomethylthio)ethane;

alicyclic polyisocyanate compounds such as isophorone diisocyanate, bis(isocyanatomethyl)cyclohexane, dicyclohexylmethane-4,4′-diisocyanate, cyclohexane diisocyanate, methylcyclohexane diisocyanate, dicyclohexyldimethylmethane isocyanate, 2,5-bis(isocyanatomethyl)bicyclo-[2.2.1]-heptane, 2,6-bis(isocyanatomethyl)bicyclo-[2.2.1]-heptane, 3,8-bis(isocyanatomethyl)tricyclodecane, 3,9-bis(isocyanatomethyl)tricyclodecane, 4,8-bis(isocyanatomethyl)tricyclodecane, and 4,9-bis(isocyanatomethyl)tricyclodecane;

aromatic polyisocyanate compounds such as phenylene diisocyanate, 2,4-tolylene diisocyanate, 2,6-tolylene diisocyanate, 4,4′-diphenylmethane diisocyanate, and diphenylsulfide-4,4-diisocyanate; and

heterocyclic polyisocyanate compounds such as 2,5-diisocyanatothiophene, 2,5-bis(isocyanatomethyl)thiophene, 2,5-diisocyanatotetrahydrothiophene, 2,5-bis(isocyanatomethyl)tetrahydrothiophene, 3,4-bis(isocyanatomethyl)tetrahydrothiophene, 2,5-diisocyanato-1,4-dithiane, 2,5-bis(isocyanatomethyl)-1,4-dithiane, 4,5-diisocyanato-1,3-dithiolane, and 4,5-bis(isocyanatomethyl)-1,3-dithiolane. As the iso(thio)cyanate compound (B), one or two or more selected from these compounds can be used in combination.

In addition, halogen-substituted products such as chlorine-substituted products or bromine-substituted products, alkyl-substituted products, alkoxy-substituted products, nitro-substituted products, prepolymer-type modified products with polyhydric alcohols, carbodiimide-modified products, urea-modified products, biuret-modified products, dimerization or trimerization reaction products, or the like, of these compounds, can also be used.

Examples of the isothiocyanate compound can include aliphatic polyisothiocyanate compounds such as hexamethylene diisothiocyanate, lysine diisothiocyanate methyl ester, lysine triisothiocyanate, m-xylylene diisothiocyanate, bis(isothiocyanatomethyl)sulfide, bis(isothiocyanatoethyl)sulfide, and bis(isothiocyanatoethyl)disulfide;

alicyclic polyisothiocyanate compounds such as isophorone diisothiocyanate, bis(isothiocyanatomethyl)cyclohexane, dicyclohexylmethane diisothiocyanate, cyclohexane diisothiocyanate, methylcyclohexane diisothiocyanate, 2,5-bis(isothiocyanatomethyl)bicyclo-[2.2.1]-heptane, 2,6-bis(isothiocyanatomethyl)bicyclo-[2.2.1]-heptane, 3,8-bis(isothiocyanatomethyl)tricyclodecane, 3,9-bis(isothiocyanatomethyl)tricyclodecane, 4,8-bis(isothiocyanatomethyl)tricyclodecane, and 4,9-bis(isothiocyanatomethyl)tricyclodecane;

aromatic polyisothiocyanate compounds such as tolylene diisothiocyanate, 4,4′-diphenylmethane diisothiocyanate, and diphenylsulfide-4,4′-diisothiocyanate; and

sulfur-containing heterocyclic polyisothiocyanate compounds such as 2,5-diisothiocyanatothiophene, 2,5-bis(isothiocyanatomethyl)thiophene, 2,5-isothiocyanatotetrahydrothiophene, 2,5-bis(isothiocyanatomethyl)tetrahydrothiophene, 3,4-bis(isothiocyanatomethyl)tetrahydrothiophene, 2,5-diisothiocyanato-1,4-dithiane, 2,5-bis(isothiocyanatomethyl)-1,4-dithiane, 4,5-diisothiocyanato-1,3-dithiolane, and 4,5-bis(isothiocyanatomethyl)-1,3-dithiolane. As the iso(thio)cyanate compound (B), one or two or more selected from these compounds can be used in combination.

In addition, halogen-substituted products such as chlorine-substituted products or bromine-substituted products, alkyl-substituted products, alkoxy-substituted products, nitro-substituted products, prepolymer-type modified products with polyhydric alcohols, carbodiimide-modified products, urea-modified products, biuret-modified products, dimerization or trimerization reaction products, or the like, of these compounds, can also be used.

In the first embodiment, the iso(thio)cyanate compound (B) is preferably at least one selected from the group consisting of hexamethylene diisocyanate, pentamethylene diisocyanate, xylylene diisocyanate, isophorone diisocyanate, bis(isocyanatomethyl)cyclohexane, dicyclohexylmethane-4,4′-diisocyanate, 2,5-bis(isocyanatomethyl)bicyclo-[2.2.1]-heptane, 2,6-bis(isocyanatomethyl)bicyclo-[2.2.1]-heptane, tolylene diisocyanate, phenylene diisocyanate, and 4,4′-diphenylmethane diisocyanate.

More preferably, at least one selected from the group consisting of xylylene diisocyanate, bis(isocyanatomethyl)cyclohexane, dicyclohexylmethane-4,4′-diisocyanate, 2,5-bis(isocyanatomethyl)bicyclo-[2.2.1]-heptane, and 2,6-bis(isocyanatomethyl)bicyclo-[2.2.1]-heptane can be used.

In the iso(thio)cyanate compound of the first embodiment, a ratio (a/b) of a number of moles a of an amino group in the amine compound (A) to a number of moles b of an iso(thio)cyanato group in the iso(thio)cyanate compound (B) is preferably less than 1.0.

When the a/b is within the above range, a cured product having suppressed turbidity can be obtained.

Furthermore, from the viewpoint of the effect in the first embodiment, a ratio ((a+c)/b) of a total number of moles (a+c) of the number of moles a of the amino group in the amine compound (A) and a number of moles c of the mercapto groups in the polythiol compound (C) to the number of moles b of the iso(thio)cyanato group in the iso(thio)cyanate compound (B) is 0.70 to 1.30, preferably 0.70 to 1.20, and more preferably 0.90 to 1.10.

<<Polymerizable Composition for Optical Material>>

The polymerizable composition for an optical material of the first embodiment contains the iso(thio)cyanate compound of the first embodiment.

The polymerizable composition for an optical material of the first embodiment may contain a component other than the iso(thio)cyanate compound of the first embodiment.

Hereinafter, each component used in the polymerizable composition for an optical material of the first embodiment will be described in detail.

[Iso(thio)cyanate Compound (B)]

The polymerizable composition for an optical material of the first embodiment may contain the iso(thio)cyanate compound (B) described above.

That is, the polymerizable composition for an optical material of the first embodiment may further contain the iso(thio)cyanate compound (B) described above in addition to the iso(thio)cyanate compound that is a reaction product between the amine compound (A) and the iso(thio)cyanate compound (B).

Specific and preferred aspects and the like of the iso(thio)cyanate compound (B) are as described for the above section [Iso(thio)cyanate compound (B)].

[Polythiol Compound (C)]

The polymerizable composition for an optical material of the first embodiment preferably further contains a thiol compound (C) including at least one of a dithiol compound (c1) having two mercapto groups or a polythiol compound (c2) having three or more mercapto groups.

The thiol compound (C) in the first embodiment preferably includes both of the dithiol compound (c1) having two mercapto groups and the polythiol compound (c2) having three or more mercapto groups.

(Dithiol Compound (c1))

The dithiol compound (c1) is a thiol having two mercapto groups, in other words, a divalent (bifunctional) thiol.

Examples of the dithiol compound (c1) include methane dithiol, 1,2-ethanedithiol, 1,2-cyclohexanedithiol, bis(2-mercaptoethyl)ether, diethylene glycol bis(2-mercaptoacetate), diethylene glycol bis(3-mercaptopropionate), ethylene glycol bis(2-mercaptoacetate), ethylene glycol bis(3-mercaptopropionate), bis(mercaptomethyl)sulfide, bis(mercaptomethyl)disulfide, bis(mercaptoethyl)sulfide, bis(mercaptoethyl)disulfide, bis(mercaptopropyl)sulfide, bis(mercaptomethylthio)methane, bis(2-mercaptoethylthio)methane, bis(3-mercaptopropylthio)methane, 1,2-bis(mercaptomethylthio)ethane, 1,2-bis(2-mercaptoethylthio)ethane, 1,2-bis(3-mercaptopropylthio)ethane, 2,5-dimercaptomethyl-1,4-dithiane, 2,5-dimercapto-1,4-dithiane, 2,5-dimercaptomethyl-2,5-dimethyl-1,4-dithiane, and esters of thioglycolic and mercaptopropionic acids thereof;

aliphatic polythiol compounds such as bis(2-mercaptoethyl)sulfide, hydroxymethyl sulfide bis(2-mercaptoacetate), hydroxymethyl sulfide bis(3-mercaptopropionate), hydroxyethyl sulfide bis(2-mercaptoacetate), hydroxyethyl sulfide bis(3-mercaptopropionate), hydroxymethyl disulfide bis(2-mercaptoacetate), hydroxymethyl disulfide bis(3-mercaptopropionate), hydroxyethyl disulfide bis(2-mercaptoacetate), hydroxyethyl disulfide bis(3-mercaptopropionate), 2-mercaptoethyl ether bis(2-mercaptoacetate), 2-mercaptoethyl ether bis(3-mercaptopropionate), thiodiglycolic acid bis(2-mercaptoethyl ester), thiodipropionic acid bis(2-mercaptoethyl ester), dithiodiglycolic acid bis(2-mercaptoethyl ester), dithiodipropionic acid bis(2-mercaptoethyl ester), and 4,6-bis(mercaptomethylthio)-1,3-dithiane;

aromatic polythiol compounds such as 1,2-dimercaptobenzene, 1,3-dimercaptobenzene, 1,4-dimercaptobenzene, 1,2-bis(mercaptomethyl)benzene, 1,3-bis(mercaptomethyl)benzene, 1,4-bis(mercaptomethyl)benzene, 1,2-bis(mercaptoethyl)benzene, 1,3-bis(mercaptoethyl)benzene, 1,4-bis(mercaptoethyl)benzene, 2,5-toluenedithiol, 3,4-toluenedithiol, 1,5-naphthalenedithiol, and 2,6-naphthalenedithiol;

heterocyclic polythiol compounds such as 2-methylamino-4,6-dithiol-sym-triazine, 3,4-thiophene dithiol, bismuthiol, 4,6-bis(mercaptomethylthio)-1,3-dithiane, 2-(2,2-bis(mercaptomethylthio)ethyl)-1,3-dithietane; and the like.

From the viewpoint of the effect in the first embodiment, the dithiol compound (c1) is preferably at least one selected from the group consisting of 2,5-dimercaptomethyl-1,4-dithiane, ethylene glycol bis(3-mercaptopropionate), 4,6-bis(mercaptomethylthio)-1,3-dithiane, 2-(2,2-bis(mercaptomethylthio)ethyl)-1,3-dithietane, and bis(2-mercaptoethyl)sulfide.

Particularly preferably, at least one compound selected from the group consisting of 2,5-dimercaptomethyl-1,4-dithiane, ethylene glycol bis(3-mercaptopropionate), 4,6-bis(mercaptomethylthio)-1,3-dithiane, and bis(2-mercaptoethyl)sulfide is used.

(Polythiol Compound (c2))

The polythiol compound (c2) is a trivalent (trifunctional) or higher polyvalent (polyfunctional) thiol having three or more mercapto groups, in other words.

Examples of the polythiol compound (c2) include 1,2,3-propanetrithiol, tetrakis(mercaptomethyl)methane, trimethylolpropane tris(2-mercaptoacetate), trimethylolpropane tris(3-mercaptopropionate), trimethylolethane tris(2-mercaptoacetate), trimethylolethane tris(3-mercaptopropionate), pentaerythritol tetrakis(2-mercaptoacetate), pentaerythritol tetrakis(3-mercaptopropionate), 1,2,3-tris(mercaptomethylthio)propane, 1,2,3-tris(2-mercaptoethylthio)propane, 1,2,3-tris(3-mercaptopropylthio)propane, 4-mercaptomethyl-1,8-dimercapto-3,6-dithiaoctane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, tetrakis(mercaptomethylthiomethyl)methane, tetrakis(2-mercaptoethylthiomethyl)methane, tetrakis(3-mercaptopropylthiomethyl)methane, bis(2,3-dimercaptopropyl)sulfide, and esters of thioglycolic acids and mercaptopropionic acids thereof;

aliphatic polythiol compounds such as 1,1,3,3-tetrakis(mercaptomethylthio)propane, 1,1,2,2-tetrakis(mercaptomethylthio)ethane, tris(mercaptomethylthio)methane, and tris(mercaptoethylthio)methane;

aromatic polythiol compounds such as 1,3,5-trimercaptobenzene, 1,3,5-tris(mercaptomethyl)benzene, 1,3,5-tris(mercaptomethyleneoxy)benzene, and 1,3,5-tris(mercaptoethyleneoxy)benzene;

heterocyclic polythiol compounds such as 2,4,6-trimercapto-s-triazine and 2,4,6-trimercapto-1,3,5-triazine; and the like.

The polythiol compound (c2) that can be used in the first embodiment is preferably at least one selected from the group consisting of trimethylolpropane tris(3-mercaptopropionate), pentaerythritol tetrakis(2-mercaptoacetate), pentaerythritol tetrakis(3-mercaptopropionate), 4-mercaptomethyl-1,8-dimercapto-3,6-dithiaoctane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, and 1,1,3,3-tetrakis(mercaptomethylthio)propane, from the viewpoint of the effect in the first embodiment.

Particularly preferably, at least one compound selected from the group consisting of 4-mercaptomethyl-1,8-dimercapto-3,6-dithiaoctane, 5,7-dimercaptomethyl-1,11-dimercapto-3,6,9-trithiaundecane, 4,7-dimercaptomethyl-1,11-dimercapto-3,6,9-trithiaundecane, and 4,8-dimercaptomethyl-1,11-dimercapto-3,6,9-trithiaundecane is used.

When the thiol compound (C) includes both of the dithiol compound (c1) and the polythiol compound (c2), a ratio (c1/c2) of a number of moles c1 of the mercapto groups of the dithiol compound (c1) to a number of moles c2 of the mercapto groups of the polythiol compound (c2) is preferably in a range of from 1 to 13, more preferably in a range of from 1 to 11, and still more preferably in a range of from 1 to 9.

When the c1/c2 is within the above range, a cured product having good impact resistance and suppressed turbidity can be obtained.

The number of moles c1 of the mercapto groups of the dithiol compound (c1) and the number of moles c2 of the mercapto groups of the polythiol compound (c2) can be calculated from the number of mercapto groups and molecular weight of the thiol used, and the amount of the thiol used. Alternatively, these numbers of moles c1 and c2 can be determined by a method known in the art such as titration.

[Polyol Compound (G)]

In the first embodiment, the polymerizable composition for an optical material contains a polyol compound (G) having two or more hydroxy groups as necessary. The polyol compound (G) is a dihydric (bifunctional) or higher polyhydric alcohol having two or more hydroxy groups, in other words.

Examples of the polyol compound that is a dihydric or higher polyhydric alcohol include linear, branched or cyclic aliphatic polyols such as 1,2-ethanediol, 1,3-propanediol, 1,2-propanediol, 1,4-butanediol, 1,3-butanediol, glycerol, neopentyl glycol, trimethylolethane, trimethylolpropane, ditrimethylolpropane, erythritol, pentaerythritol, dipentaerythritol, diethylene glycol, dipropylene glycol, higher polyalkylene glycol, cyclobutanediol, cyclopentanediol, cyclohexanediol, cycloheptanediol, cyclooctanediol, cyclohexanedimethanol, tricyclohexane dimethanol, tricyclodecane dimethanol, tripropylene glycol, polypropylene glycol (diol type), polycaprolactone triol, triethylene glycol, propylene glycol, tripropylene glycol, hydroxypropyl cyclohexanol, tricyclo[5,2,1,0,2,6]decane-dimethanol, bicyclo[4,3,0]-nonanediol, dicyclohexanediol, tricyclo[5,3,1,1]dodecanediol, bicyclo[4,3,0]nonanedimethanol, tricyclo[5,3,1,1]dodecane-diethanol, hydroxypropyltricyclo[5,3,1,1]dodecanol, spiro[3,4]octanediol, butylcyclohexanediol, 1,1′-bicyclohexylidenediol, cyclohexanetriol, maltitol, and lactitol; and

aromatic polyols such as cyclohexanediethanoldihydroxybenzene, benzenetriol, hydroxybenzyl alcohol, dihydroxytoluene, 4,4′-oxybisphenol, 4,4′-dihydroxybenzophenone, 4,4′-thiobisphenol, phenolphthalein, bis(4-hydroxyphenyl)methane, 4,4′-(1,2-ethenediyl)bisphenol, 4,4′-sulfonylbisphenol, 4,4′-isopropylidenebis(2,6-dibromophenol), 4,4′-isopropylidenebis(2,6-dichlorophenol), 4,4′-isopropylidenebis(2,3,5,6-tetrachlorophenol), 4,4′-isopropylidene-biscyclohexanol, 4,4′-oxybiscyclohexanol, 4,4′-thiobiscyclohexanol, and bis(4-hydroxycyclohexanol)methane.

Among them, as the polyol compound (G), it is preferable to use the diol compound (g1) having two hydroxy groups from the viewpoint of a lower haze of the resulting resin and excellent heat resistance.

Preferably, at least one selected from the group consisting of a linear aliphatic diol compound, a branched aliphatic diol compound, a cyclic aliphatic diol compound, and an aromatic diol compound is used as the diol compound (g1).

Among them, polypropylene glycols such as dipropylene glycol and tripropylene glycol, cyclohexanedimethanol, tricyclodecane dimethanol, and propylene glycol are preferably used as the diol compound (g1) from the viewpoint of the handleability of the polymerizable composition and the heat resistance of the resulting molded body.

(Polymerization Catalyst)

The polymerizable composition for an optical material of the first embodiment preferably further contains a catalyst.

Examples of the catalyst include Lewis acids, tertiary amines, organic acids, and amine organic acid salts. Lewis acids, amines, and amine organic acid salts are preferable, and dimethyltin chloride, dibutyltin dichloride, and dibutyltin laurate are more preferable.

The polymerizable composition for an optical material of the first embodiment preferably further contains an organotin compound (D) and a tertiary amine compound (E).

The polymerizable composition for an optical material of the first embodiment further contains the organotin compound (D) and the tertiary amine compound (E), so that a cured product with suppressed striae can be obtained.

The organotin compound (D) and the tertiary amine compound (E) in the first embodiment will be described in detail in the sections of the organotin compound (D) and the tertiary amine compound (E) in the second embodiment that will be described later.

(Ultraviolet Absorber)

The polymerizable composition for an optical material of the first embodiment preferably further contains an ultraviolet absorber.

Examples of the ultraviolet absorber can include benzophenone-based compounds, triazine-based compounds, and benzotriazole-based compounds.

Examples of the ultraviolet absorber include benzophenone-based ultraviolet absorbers such as 2,2′-dihydroxy-4-methoxybenzophenone, 2-hydroxy-4-acryloyloxybenzophenone, 2-hydroxy-4-acryloyloxy-5-tert-butylbenzophenone, and 2-hydroxy-4-acryloyloxy-2′,4′-dichlorobenzophenone;

triazine-based ultraviolet absorbers such as 2-[4-[(2-hydroxy-3-dodecyloxypropyl)oxy]-2-hydroxyphenyl]4,6-bis(2,4-dimethylphenyl)-1,3,5-triazine, 2-[4-(2-hydroxy-3-tridecyloxypropyl)oxy]-2-hydroxyphenyl]-4,6-bis(2,4dimethylphenyl)-1,3,5-triazine, 2-[4-[(2-hydroxy-3-(2′-ethyl)hexyl)oxy]-2-hydroxyphenyl]-4,6-bis(2,4-dimethylphenyl)-1,3,5-triazine, 2,4-bis(2-hydroxy-4-butyloxyphenyl)-6-(2,4-bis-butyloxyphenyl)-1,3,5-triazine, and 2-(2-hydroxy-4-[1-octyloxycarbonylethoxy]phenyl)-4,6-bis(4-phenylphenyl)-1,3,5-triazine; and

benzotriazole-based ultraviolet absorbers such as 2-(2H-benzotriazole-2-yl)-4-methylphenol, 2-(2H-benzotriazole-2-yl)-4-tert-octylphenol, 2-(2H-benzotriazole-2-yl)-4,6-bis(1-methyl-1 phenylethyl) phenol, 2-(2H-benzotriazole-2-yl)-4,6-di-tert-pentylphenol, and 2,2′-methylenebis[6-(2H-benzotriazole-2-yl)-4-(1,1,3,3-tetramethylbutyl)phenol], and preferably include benzotriazole-based ultraviolet absorbers such as 2-(2H-benzotriazole-2-yl)-4-tert-octylphenol. These ultraviolet absorbers may be used alone or in combination of two or more thereof.

The polymerizable composition for an optical material of the first embodiment preferably further contains an ultraviolet absorber (F) having a maximum absorption peak in a range of from 350 nm to 370 nm and including a compound represented by the following general formula (6).

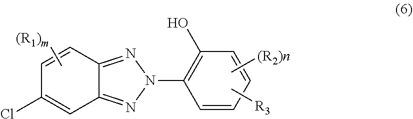

In general formula (6), each of R₁ and R₂ independently represents an alkyl group having 1 to 8 carbon atoms. When a plurality of R₁ is present, respective R₁'s may be the same as or different from each other. When a plurality of R₂ is present, respective R₂'s may be the same as or different from each other. R₃ represents a functional group having 2 to 15 carbon atoms and containing an ester bond. m represents an integer from 0 to 3; and n represents an integer from 0 to 3.

The polymerizable composition for an optical material of the first embodiment further contains the ultraviolet absorber (F), so that a cured product excellent in light blocking properties against light having a wavelength of 400 nm can be obtained.

The ultraviolet absorber (F) in the first embodiment will be described in detail in the section of the ultraviolet absorber (F) in the third embodiment that will be described later.

(Other Components)

The polymerizable composition for an optical material of the first embodiment may further contain additives such as a polymerization catalyst, an internal mold release agent, a resin modifier, a light stabilizer, a bluing agent, an ultraviolet absorber, an antioxidant, a coloring inhibitor, a dye, and a photochromic dye according to properties desired for the application to which the composition is to be applied.

That is, in order to adjust various physical properties such as optical properties, impact resistance, and specific gravity of the obtained molded body and to adjust the handleability of each component of the polymerizable composition, a modifier can be added to the polymerizable composition of the first embodiment as long as the effect in the first embodiment is not impaired.

(Internal Mold Release Agent)

The polymerization composition of the first embodiment can contain an internal mold release agent for the purpose of improving releasability from the mold after molding.

As the internal mold release agent, an acidic phosphoric acid ester can be used. Examples of the acidic phosphoric acid ester can include phosphoric acid mono-ester and phosphoric acid di-ester, and these phosphoric acid mono-ester and phosphoric acid di-ester can be respectively used alone or in combination of two or more thereof.

For example, Zelec UN manufactured by STEPAN, an internal mold release agent for MR manufactured by Mitsui Chemicals, Inc., JP series manufactured by Johoku Chemical Co., Ltd., PHOSPHANOL series manufactured by TOHO Chemical Industry Co., Ltd., AP and DP series manufactured by DAIHACHI CHEMICAL INDUSTRY CO., LTD., and the like can be used.

A content of the internal mold release agent is preferably 1000 ppm by mass to 7500 ppm by mass, and more preferably 3000 ppm by mass to 5000 ppm by mass, based on a total mass of the polymerizable composition (excluding a mass of the additive).

(Resin Modifier)

Also, in order to adjust various physical properties such as optical properties, impact resistance, and specific gravity of the obtained resin and to adjust viscosity and pot life of the composition, a resin modifier can be added to the polymerizable composition of the first embodiment as long as the effect in the first embodiment is not impaired.

Examples of the resin modifier include an episulfide compound, an alcohol compound different from the above-described polyol compound, an amine compound different from the above-described amine compound, an epoxy compound, an organic acid and an anhydride thereof, and an olefin compound including a (meth) acrylate compound.

(Light Stabilizer)

As the light stabilizer, a hindered amine-based compound can be used. Examples of the hindered amine-based compound include Lowilite 76 and Lowilite 92 manufactured by Chemtura, Tinuvin 144, Tinuvin 292, and Tinuvin 765 manufactured by BASF, ADK STAB LA-52 and LA-72 manufactured by ADEKA Corporation, and JF-95 manufactured by Johoku Chemical Co., Ltd. as commercially available products.

(Bluing Agent)

Examples of the bluing agent include those having an absorption band in an orange to yellow wavelength region in the visible light region and having a function of adjusting hue of an optical material containing the resin. More specifically, the bluing agent contains a substance exhibiting blue to purple.

<Method for Producing Iso(thio)cyanate Compound>

An iso(thio)cyanate compound production method of the first embodiment is a production method of an iso(thio)cyanate compound for producing an iso(thio)cyanate compound of the first embodiment, and the method includes:

a step (also referred to as step (i)) of producing the iso(thio)cyanate compound by reacting the amine compound (A) with the iso(thio)cyanate compound (B) under a condition that satisfies at least one of the following condition 1 or condition 2:

Condition 1: a mixture of the amine compound (A) and the iso(thio)cyanate compound (B) is reacted by stirring at a stirring rate of 150 to 200 rpm (revolutions per minute), and the amine compound (A) and the iso(thio)cyanate compound (B) are reacted in a reaction device in which a ratio (D/d) of a reactor diameter (D) to a stirring blade diameter (d) is 3.0 or less,

Condition 2: a mixture of the amine compound (A) and the iso(thio)cyanate compound (B) is reacted by stirring at a stirring rate of 200 rpm or more.

[Step (i)]

In the step (i), the amine compound (A) and the iso(thio)cyanate compound (B) are reacted under the condition that satisfies at least one of Condition 1 or Condition 2 to produce an iso(thio)cyanate compound.

Thus, the value of Mw/Mn of the iso(thio)cyanate compound to be produced can be easily set to the above-described range. This makes it possible to suppress turbidity in the resulting cured product.

In the step (i), the reaction between the amine compound (A) and the iso(thio)cyanate compound (B) may be completed once, or may be completed in plural portions.

For example, the step (i) may include:

a step of reacting a part of the iso(thio)cyanate compound (B) with the amine compound (A) to obtain an iso(thio)cyanate compound; and

a step of reacting another amine compound (A) and the rest of the iso(thio)cyanate compound (B) with the iso(thio)cyanate compound described above to obtain an iso(thio)cyanate compound.

(Condition 1)

Condition 1 is a condition in which a mixture of the amine compound (A) and the iso(thio)cyanate compound (B) is reacted by stirring at a stirring rate of 150 to 200 rpm, and the amine compound (A) and the iso(thio)cyanate compound (B) are reacted in a reaction device in which a ratio (D/d) of a reactor diameter (D) to a stirring blade diameter (d) is 3.0 or less.

Due to Condition 1, the value of Mw/Mn of the iso(thio)cyanate compound to be produced can be easily set to the above-described range.

From the same viewpoint as described above, the ratio (D/d) of the reactor diameter (D) to the stirring blade diameter (d) is preferably 2.5 or less, and more preferably 2.0 or less.

A lower limit of the ratio (D/d) of the reactor diameter (D) to the stirring blade diameter (d) is not particularly limited. For example, the ratio (D/d) of the reactor diameter (D) to the stirring blade diameter (d) may be more than 1.0 and may be 1.1 or more.

(Condition 2)

Condition 2 is a condition in which a mixture of the amine compound (A) and the iso(thio)cyanate compound (B) is reacted by stirring at a stirring rate of 200 rpm or more.

Due to Condition 2, the value of Mw/Mn of the iso(thio)cyanate compound to be produced can be easily set to the above-described range.

From the same viewpoint as described above, the stirring rate is preferably 250 rpm or more, more preferably 300 rpm or more, and still more preferably 350 rpm or more.

An upper limit of the stirring rate is not particularly limited.

For example, the stirring rate may be 500 rpm or less or 400 rpm or less.

In the step (i), a predetermined amount of the amine compound (A) is charged at once or charged in portions into the iso(thio)cyanate compound (B), and these compounds are reacted.

The ratio (a/b) of the number of moles a of the amino group in the amine compound (A) to the number of moles b of the iso(thio)cyanato group in the iso(thio)cyanate compound (B) is preferably less than 1.0.

When the a/b is within the above range, a cured product having suppressed turbidity can be obtained.

The a/b is within the above range, thereby making it possible to prevent an amino group from remaining in the resulting iso(thio)cyanate compound. This makes it possible to reduce heat of the reaction with the amine compound (A) and to prolong pot life.

As a result, workability until casting can be significantly improved. In addition, the generation of striae in the obtained cured product can be suppressed.

The reaction between the amine compound (A) and the iso(thio)cyanate compound (B) may be carried out in the presence of additives. The reaction temperature varies depending on the types and amounts of the compounds and additives to be used and the nature of the iso(thio)cyanate compound to be prepared, and thus is not generally limited, and is appropriately selected in consideration of operability, safety, convenience, and the like.

<Method for Producing Polymerizable Composition for Optical Material>

A method for producing a polymerizable composition for an optical material of the first embodiment includes: a step of producing an iso(thio)cyanate compound by the iso(thio)cyanate compound production method of the first embodiment (also referred to as iso(thio)cyanate compound production step); and a step (also referred to as step (ii)) of mixing the iso(thio)cyanate compound with a thiol compound (C) including at least one of a dithiol compound (c1) having two mercapto groups or a polythiol compound (c2) having three or more mercapto groups to produce a composition.

The polymerizable composition for an optical material of the first embodiment is prepared by a method in which the amine compound (A) and the iso(thio)cyanate compound (B) are reacted to obtain an iso(thio)cyanate compound, and then a polythiol compound (C) and other components are added to and mixed with the iso(thio)cyanate compound.

The method for producing a polymerizable composition for an optical material is carried out by the above method, so that a cured product having suppressed turbidity can be suitably obtained.

In the first embodiment, the method for producing a polymerizable composition for an optical material may be:
a method in which after the iso(thio)cyanate compound of the first embodiment is obtained by the iso(thio)cyanate compound production step, a polythiol compound (C) is added to the iso(thio)cyanate compound, and then a polyol compound (G) is added to and mixed with the mixture;
a method in which after the iso(thio)cyanate compound of the first embodiment is obtained by the iso(thio)cyanate compound production step, a polyol compound (G) is added to the iso(thio)cyanate compound, and then a polythiol compound (C) is added to the mixture; or
a method in which after the iso(thio)cyanate compound of the first embodiment is obtained by the iso(thio)cyanate compound production step, a mixture of a polythiol compound (C) and a polyol compound (G) is added to the iso(thio)cyanate compound.

Hereinafter, each step in the method for producing a polymerizable composition for an optical material of the first embodiment will be described.

[Iso(thio)cyanate Compound Production Step]

Details of the iso(thio)cyanate compound production step are as described in the above section <Method for producing iso(thio)cyanate compound>.

[Step (ii)]

The step (ii) includes a mixing the iso(thio)cyanate compound with a thiol compound (C) including at least one of a dithiol compound (c1) having two mercapto groups or a polythiol compound (c2) having three or more mercapto groups to produce a composition.

The mixing temperature varies depending on the compound to be used, and thus is not generally limited, and is appropriately selected in consideration of operability, safety, convenience, and the like, but is preferably 25° C. or lower. Heating may be performed depending on the solubility of the compound to be used. The heating temperature is determined in consideration of stability and safety of the compound.

When the polyol compound (G) is used, it is preferable to add and mix the polyol compound (G) to/with the iso(thio)cyanate compound obtained in the step (i) during the step (ii) as described above. The addition of the polyol compound (G) may be performed before, after, or simultaneously with the addition of the polythiol compound (C), or a mixture of the polythiol compound (C) and the polyol compound (G) may be added to the iso(thio)cyanate compound.

When the polyol compound (G) is used, it is preferable to use the polyol compound (G) such that a number of moles d of the hydroxy groups in the polyol compound (G) with respect to the number of moles c of the mercapto groups in the polythiol compound (C) is from 0.01 to 0.7, and preferably from 0.02 to 0.6. When the polyol compound (G) is used, a resin having a high refractive index, excellent transparency, and heat resistance can be obtained without causing a decrease in impact resistance by adjusting the number of moles d to be in the above range.

When the polyol compound (G) is used, a ratio ((a+c+d)/b) of a total number of moles (a+c+d) of the number of moles a of the amino group in the amine compound (A), the number of moles c of the mercapto groups in the polythiol compound (C), and the number of moles d of the hydroxy groups in the polyol compound (G) to the number of moles b of the iso(thio)cyanato group in the iso(thio)cyanate compound (B) is 0.7 to 1.30, preferably 0.70 to 1.20, and more preferably 0.90 to 1.10.

The number of moles a of the amino group in the amine compound (A), the number of moles b of the iso(thio)cyanato group in the iso(thio)cyanate compound (B), the number of moles c of the mercapto groups in the polythiol compound (C), and the number of moles d of the hydroxy group in the polyol compound (G) can be theoretically determined from the number of functional groups and the molecular weight or the weight average molecular weight of the compound to be used, and the amounts of these compounds to be used. Alternatively, the numbers of moles can be determined by a method known in the art such as titration.

<Molded Body>

The molded body of the first embodiment can be obtained by curing the polymerizable composition for an optical material.

The molded body of the first embodiment is a molded body obtained by curing the polymerizable composition for an optical material.

<Optical Material>

The optical material of the first embodiment includes the molded body of the first embodiment.

That is, the molded body obtained by curing the polymerizable composition for an optical material of the first embodiment can be used as the optical material.

The method for producing an optical material of the first embodiment includes: a step (also referred to as step a1) of injecting the polymerizable composition for an optical material of the first embodiment into a mold; and a step (also referred to as step b1) of polymerizing and curing the polymerizable composition for an optical material in the mold.

Hereinafter, the step a1 and the step b1 will be described.

[Step a1]

First, the polymerizable composition is injected into a molding mold (mold) held by a gasket, a tape, or the like. At this time, depending on physical properties required of the obtained plastic lens, it is often preferable to perform defoaming treatment under reduced pressure, filtration treatment under applied or reduced pressure, and the like as necessary.

[Step b1]

The polymerization conditions are not limited because the conditions greatly vary depending on the formulation of the polymerizable composition, the type and amount of the catalyst to be used, the shape of the mold, and the like, but the polymerization is performed at a temperature of about −50 to 150° C. over 1 to 50 hours. In some cases, it is preferable to hold or gradually raise the temperature in a temperature range of from 10 to 150° C. and cure the polymerizable composition in from 1 to 25 hours.

In the method for producing an optical material of the first embodiment, treatment such as annealing may be performed as necessary. The treatment temperature is usually 50 to 150° C., but is preferably 90 to 140° C., and more preferably 100 to 130° C.

In the method for producing an optical material of the first embodiment, in addition to the “other components” described in the section of the polymerizable composition for an optical material, various additives such as a chain extender, a crosslinking agent, an oil soluble dye, a filler, and an adhesion improver may be added according to the purpose.

In the method for producing an optical material of the first embodiment, optical materials having various shapes can be obtained by changing the mold during casting polymerization.

The optical material of the first embodiment can have various shapes since it includes a coating layer formed as necessary, other members, and the like.

<Plastic Lens>

The plastic lens of the first embodiment includes the molded body of the first embodiment.

That is, the molded body obtained by curing the polymerizable composition for an optical material of the first embodiment can be used as an optical material, and further can be used as a plastic lens.

As the plastic lens, a plastic spectacle lens is suitable.

<Plastic Spectacle Lens>

The optical material obtained by curing the polymerizable composition for an optical material of the first embodiment can be used as a plastic spectacle lens that is a lens substrate for a spectacle lens.

For this lens substrate, a coating layer may be applied to one surface or both surfaces as necessary. Examples of the coating layer include a hard coat layer, an antireflection layer, an antifogging coat film layer, an antifouling layer, a water-repellent layer, a primer layer, and a photochromic layer. Each of these coating layers can be used alone, or a plurality of coating layers can be used in a multilayered manner. When the coating layer is applied to both surfaces, the same coating layer may be applied to each surface, or different coating layers may be applied to both surfaces.

Regarding the plastic spectacle lens in the first embodiment, a known technique can be used for details of a specific aspect, an aspect of the coating layer, a method for forming the coating layer, and the like.

For example, the contents of WO 2018/079518 A can be adopted as the plastic spectacle lens in the first embodiment.

When the optical material of the first embodiment is applied to a spectacle lens, a hard coat layer and/or an antireflection coat layer can be formed on at least one surface of an optical material (lens substrate) obtained by curing the polymerizable composition of the first embodiment. Furthermore, other layers as described above can also be provided. Since the spectacle lens thus obtained uses a lens produced from the specific polymerizable composition of the first embodiment, the spectacle lens is excellent in impact resistance even when including these coat layers.

The hard coat layer is a coating layer provided on at least one surface of an optical material (lens substrate) obtained by curing the polymerizable composition of the first embodiment, and intended to impart functions such as scratch resistance, abrasion resistance, moisture resistance, hot water resistance, heat resistance, and light resistance to the surface of the obtained spectacle lens. The hard coat layer is obtained from a composition containing one or more metal oxides selected from a group of elements: silicon, titanium, zirconium, tin, aluminum, tungsten, and antimony, and a silane compound having at least one or more functional groups selected from an alkyl group, an allyl group, an alkoxy group, a methacryloxy group, an acryloxy group, an epoxy group, an amino group, an isocyanato group, and a mercapto group, and a hydrolyzate thereof.

A hard coat composition may contain a curing agent for the purpose of accelerating curing. Specific examples of the curing agent include inorganic, organic acids, amines, metal complexes, organic acid metal salts, and metal chlorides. A solvent may be used for preparing the hard coat composition. Specific examples of the solvent include water, alcohols, ethers, ketones, and esters.

The hard coat layer is formed by applying the hard coat composition to the surface of the lens substrate by a known application method such as spin coating or dip coating, and then curing the composition. Examples of the curing method include thermal curing and curing by irradiation with energy rays such as ultraviolet rays and visible rays. In the case of thermal curing, it is preferable to perform the thermal curing at 80 to 120° C. for 1 to 4 hours. In order to suppress the occurrence of interference fringes, a difference in refractive index between the hard coat layer and the molded body is preferably in a range of ±0.1.

Before the hard coat layer is applied, the surface of the lens substrate is preferably ultrasonically washed with an aqueous alkaline solution so as to satisfy the following conditions (a) to (d):
(a) the aqueous alkaline solution is an aqueous solution of 5 to 40% sodium hydroxide or potassium hydroxide;
(b) the treatment temperature for the aqueous alkaline solution is 30 to 60° C.,
(c) the treatment time is 3 to 5 minutes,
(d) the ultrasonic frequency is 20 to 30 kHz.

After the washing with the aqueous alkaline solution, the surface of the lens substrate may be washed with distilled water, an alcohol such as isopropanol, or the like, and dried at 50° C. to 80° C. for 5 minutes to 20 minutes.

The lens substrate composed of the molded body obtained from the polymerizable composition of the first embodiment is excellent in alkali resistance, and the occurrence of cloudiness or the like is suppressed even after the washing with an aqueous alkaline solution.

The antireflection layer is a coating layer that is provided on at least one surface of the molded body (lens substrate), and is intended to reduce reflectance caused by a difference in refractive index between air and the molded body, and significantly reduce reflection of light on a surface of the resulting plastic spectacle lens to increase transmittance. The antireflection layer in the first embodiment includes a low refractive index film layer containing silicon oxide and a high refractive index film layer containing one or more metal oxides selected from titanium oxide, zirconium oxide, aluminum oxide, zinc oxide, cerium oxide, antimony oxide, tin oxide, and tantalum oxide, and each layer may have a monolayer or multilayer structure.

When the antireflection layer has a multilayer structure, it is preferable that 5 to 7 layers are layered. It has a film thickness of preferably 100 to 300 nm, and more preferably 150 to 250 nm. Examples of a method for forming the multilayered antireflection layer include a vacuum vapor deposition method, a sputtering method, an ion plating method, an ion beam assist method, and a CVD method.

An antifogging coat film layer, an antifouling layer, or a water-repellent layer may be formed on the antireflection layer as necessary. As a method for forming the antifogging coat layer, the antifouling layer, and the water-repellent layer, a treatment method, a treatment material, and the like are not particularly limited as long as the antireflection function is not adversely affected, and known antifogging coating treatment methods, antifouling treatment methods, water-repellent treatment methods, and materials can be used. Examples of the antifogging coating method and the antifouling treatment method include a method in which a surface is covered with a surfactant, a method in which a hydrophilic film is added to the surface to make the surface water-absorbent, a method in which the surface is covered with fine irregularities to enhance water absorbability, a method in which water absorbability is achieved using photocatalytic activity, and a method in which super water-repellent treatment is applied to prevent attachment of water droplets. Examples of the water-repellent treatment method include a method in which a fluorine-containing silane compound or the like is deposited or sputtered to form a water-repellent treatment layer, and a method in which a fluorine-containing silane compound is dissolved in a solvent and then coated to form a water-repellent treatment layer.

These coating layers may contain an ultraviolet absorber for the purpose of protecting lenses and eyes from ultraviolet rays, an infrared absorber for the purpose of protecting eyes from infrared rays, a light stabilizer and an antioxidant for the purpose of improving the weather resistance of lenses, a dye and a pigment for the purpose of improving the fashionability of lenses, and further a photochromic dye and a photochromic pigment, an antistatic agent, and other known additives for improving the performance of lenses. For the layer to be coated by application, various leveling agents for the purpose of improving applicability may be used.

The optical material using the polymerizable composition of the first embodiment may be dyed using a dye suitable for the purpose, for example, of imparting fashionability and photochromic properties. Dyeing of the lens can be performed by a known dyeing method, and is usually performed by the following method.

In general, a method is used in which a lens material finished to have a predetermined optical surface is immersed (dyeing step) in a dyeing solution in which a dye to be used is dissolved or uniformly dispersed, and then the lens is heated as necessary to immobilize the dye (post-dyeing annealing step). The dye used in the dyeing step is not particularly limited as long as it is a known dye, but an oil-soluble dye or a disperse dye is usually used. The solvent to be used in the dyeing step is not particularly limited as long as the dye to be used can be dissolved or uniformly dispersed. In this dyeing step, a surfactant for dispersing a dye in the dyeing solution or a carrier for promoting dyeing may be added as necessary.

In the dyeing step, a dyeing bath is prepared by dispersing a dye and a surfactant to be added as necessary in water or a mixture of water and an organic solvent, an optical lens is immersed in the dyeing bath, and dyeing is performed at a predetermined temperature for a predetermined time. The dyeing temperature and time vary depending on the desired coloring concentration, but may be usually 120° C. or lower for about several minutes to several tens of hours, and the dyeing bath is used at a dye concentration of 0.01 to 10 mass %. When dyeing is difficult, dyeing may be performed under pressure.

The post-dyeing annealing step to be performed as necessary is a step of performing heat treatment on the dyed lens material. In the heat treatment, water remaining on the surface of the lens material dyed in the dyeing step is removed with a solvent or the like, or the solvent is air-dried, and then the lens material is retained in a furnace such as an infrared heating furnace in an air atmosphere or a resistance heating furnace for a predetermined time. In the post-dyeing annealing step, color loss of the dyed lens material is prevented (color loss prevention treatment), and moisture that has permeated the inside of the lens material at the time of dyeing is removed. In the first embodiment, when no alcohol compound is contained, unevenness after dyeing is small.

<Plastic Polarizing Lens>

The optical material obtained by curing the polymerizable composition for an optical material of the first embodiment can be used as a plastic polarizing lens that is a lens substrate for a plastic polarizing lens.

The plastic polarizing lens of the first embodiment includes: a substrate layer including the molded body of the first embodiment; and a polarizing film.

Regarding the plastic polarizing lens in the first embodiment, a known technique can be used for details of a specific aspect and the like.

For example, the contents of WO 2018/079518 A can be adopted as the plastic polarizing lens in the first embodiment.

The polarizing film in the first embodiment can be made of a thermoplastic resin. Examples of the thermoplastic resin include a polyester resin, a polycarbonate resin, a polyolefin resin, a polyimide resin, a polyvinyl alcohol resin, and a polyvinyl chloride resin. From the viewpoint of water resistance, heat resistance, and molding processability, a polyester resin and a polycarbonate resin are preferable, and a polyester resin is more preferable.

Examples of the polyester resin can include polyethylene terephthalate, polyethylene naphthalate, and polybutylene terephthalate, and polyethylene terephthalate is preferable from the viewpoint of water resistance, heat resistance, and molding processability.

Specific examples of the polarizing film include a dichroic dye-containing polyester polarizing film, an iodine-containing polyvinyl alcohol polarizing film, and a dichroic dye-containing polyvinyl alcohol polarizing film.

The polarizing film may be used after being subjected to a heat treatment for drying and stabilization.

Furthermore, in order to improve adhesion to the acrylic resin, the polarizing film may be used after being subjected to one or two or more pretreatments selected from primer coating treatment, chemical treatment (drug solution treatment such as gas or alkali), corona discharge treatment, plasma treatment, ultraviolet irradiation treatment, electron beam irradiation treatment, roughening treatment, flame treatment, and the like. Among such pretreatments, one or two or more selected from primer coating treatment, chemical treatment, corona discharge treatment, and plasma treatment are particularly preferable.

In the plastic polarizing lens of the first embodiment, a substrate layer obtained by curing the polymerizable composition for an optical material of the first embodiment is layered on one surface, i.e., the surface on the objective surface side or the surface on the eyepiece surface side of such a polarizing film, or on both surfaces of the surface on the objective surface side and the surface on the eyepiece surface side.

The substrate layer in the first embodiment may include a layer made of a plastic material such as an acrylic resin, an allyl carbonate resin, a polycarbonate resin, a polyurethane resin, a polythiourethane resin, or a polysulfide resin in addition to the layer made of the cured product of the polymerizable composition for an optical material in the first embodiment.

The plastic polarizing lens of the first embodiment is not particularly limited, but can be produced by a method in which a lens substrate produced in advance is bonded to both surfaces of a polarizing film, a method in which a polymerizable composition is cast and polymerized on both surfaces of a polarizing film, or the like. In the first embodiment, an example formed by a casting polymerization method will be described.

The method for producing a plastic polarizing lens of the first embodiment includes a step (also referred to as step a2) of disposing a polarizing film in a mold; a step (step b2) of injecting the polymerizable composition for an optical material of the first embodiment into the mold in which the polarizing film is disposed; and a step (step c2) of polymerizing and curing the polymerizable composition for an optical material to obtain a plastic polarizing lens including: a substrate layer including a molded body obtained by curing the polymerizable composition for an optical material; and a polarizing film.

Hereinafter, each step will be described in order.

[Step a2]

The step a2 is a step of disposing a polarizing film in a mold.

A polarizing film made of thermoplastic polyester or the like is disposed in a space of a lens casting mold such that at least one of film surfaces is parallel to an opposing mold inner surface. A void portion is formed between the polarizing film and the mold. The polarizing film may be shaped in advance.

[Step b2]

The step b2 is a step of injecting the polymerizable composition for an optical material of the first embodiment into the mold in which the polarizing film is disposed.

After the step a2, the polymerizable composition for an optical material of the first embodiment is injected into the void portion between the mold and the polarizing film in the space of the lens casting mold by a predetermined injection means.

[Step c2]

The step c2 is a step of polymerizing and curing the polymerizable composition for an optical material to obtain a plastic polarizing lens including: a substrate layer including a molded body obtained by curing the polymerizable composition for an optical material; and a polarizing film.

After the step b2, the lens casting mold to which the polarizing film injected with the polymerizable composition for an optical material is fixed is cured and molded by heating in an oven or in a heatable device in water or the like for several hours to several tens of hours under a predetermined temperature program.

The temperature for the polymerization curing cannot be limited because conditions vary depending on the formulation of the polymerizable composition, the type of catalyst, the shape of the mold, and the like, but the polymerization curing is performed at a temperature of 0 to 140° C. over 1 to 48 hours.

After completion of the cure molding, the plastic polarizing lens of the first embodiment in which a layer formed of a cured product of the polymerizable composition of the first embodiment is layered on at least one surface of the polarizing film can be obtained by taking out the composition from the lens casting mold.

The plastic polarizing lens of the first embodiment is desirably subjected to annealing treatment by heating the released lens for the purpose of alleviating distortion due to polymerization.

The plastic polarizing lens of the first embodiment is used by applying a coating layer on one surface or both surfaces as necessary. Examples of the coating layer include a primer layer, a hard coat layer, an antireflection layer, an antifogging coat layer, an antifouling layer, and a water-repellent layer, which are the same as those for the plastic spectacle lens.

<Application>

Next, applications of the optical material of the first embodiment will be described.

Examples of the optical material described in the first embodiment include various plastic lenses such as plastic spectacle lenses, goggles, eyeglass lenses for vision correction, lenses for imaging equipment, Fresnel lenses for liquid crystal projectors, lenticular lenses, and contact lenses, encapsulants for light emitting diodes (LED), optical waveguides, optical adhesives used for bonding optical lenses and optical waveguides, antireflection films used for optical lenses and the like, transparent coatings used for liquid crystal display device members (substrate, light guide plate, film, sheet, and the like), or sheets, films, and transparent substrates to be attached to windshields of vehicles or helmets of motorcycles.

Although the first embodiment has been described above with reference to the embodiment, the first embodiment is not limited to the above-described embodiment, and various aspects can be taken without impairing the effects of the present invention.

### Second Embodiment

<<Polymerizable Composition for Optical Material>>

The polymerizable composition for an optical material of the second embodiment contains an amine compound (A) including at least one selected from the group consisting of a compound (a1) represented by the following general formula (1) and a compound (a2) represented by the following general formula (2), a bi- or higher-functional iso(thio)cyanate compound (B), a polythiol compound (C) including at least one selected from the group consisting of a dithiol compound (c1) containing two mercapto groups and a polythiol compound (c2) containing three or more mercapto groups, an organotin compound (D), and a tertiary amine compound (E).

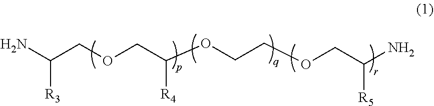

In general formula (1), each of R₃ to R₅ independently represents a hydrogen atom or a methyl group. p represents an integer from 0 to 100; q represents an integer from 0 to 100; r represents an integer from 0 to 100; and p+r equals an integer from 1 to 100. When a plurality of R₄ is present, respective R₄'s may be the same as or different from each other. When a plurality of R₅ is present, respective R₅'s may be the same as or different from each other.

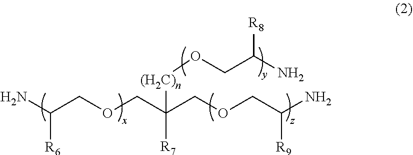

In general formula (2), each of R₆, R₈ and R₉ independently represents a hydrogen atom or a methyl group. R₇ represents a linear alkyl group having 1 to 20 carbon atoms, a branched alkyl group having 3 to 20 carbon atoms, or a cyclic alkyl group having 3 to 20 carbon atoms. x represents an integer from 0 to 200; y represents an integer from 0 to 200; z represents an integer from 0 to 200; and x+y+z equals an integer from 1 to 200. n represents an integer from 0 to 10. When a plurality of R₆ is present, respective R₆'s may be the same as or different from each other. When a plurality of R₈ is present, respective R₈'s may be the same as or different from each other. When a plurality of R₉ is present, respective R₉'s may be the same as or different from each other.

The polymerizable composition for an optical material of the second embodiment includes the above configuration, so that a cured product having suppressed striae can be obtained.

Hereinafter, each component of the polymerizable composition for an optical material of the second embodiment will be described.

[Amine Compound (A)]

Details of the structure, specific examples, preferred aspects, a preferred content and the like of the amine compound (A) used in the polymerizable composition for an optical material of the second embodiment are the same as the details of the structure, specific examples, preferred aspects, preferred content and the like of the amine compound (A) described in the section of the first embodiment.

[Iso(thio)cyanate Compound (B)]

The iso(thio)cyanate compound (B) used in the polymerizable composition for an optical material of the second embodiment is a bi- or higher-functional iso(thio)cyanate compound.

Details of specific examples, preferred aspects, and a preferred content of the iso(thio)cyanate compound (B) used in the polymerizable composition for an optical material of the second embodiment, a ratio (a/b) of a number of moles a of an amino group of the amine compound (A) to a number of moles b of an iso(thio)cyanato group of the iso(thio)cyanate compound (B), a ratio ((a+c)/b) of a total number of moles (a+c) of the number of moles a of the amino group in the amine compound (A) and a number of moles c of mercapto groups in a polythiol compound (C) to the number of moles b of the iso(thio)cyanato group in the iso(thio)cyanate compound (B), and the like are the same as the details of the specific examples, preferred aspects, and preferred content of the iso(thio)cyanate compound (B) described in the section of the first embodiment, ratio (a/b) of the number of moles a of the amino group of the amine compound (A) to the number of moles b of the iso(thio)cyanato group of the iso(thio)cyanate compound (B), ratio ((a+c)/b) of the total number of moles (a+c) of the number of moles a of the amino group in the amine compound (A) and the number of moles c of the mercapto groups in the polythiol compound (C) to the number of moles b of the iso(thio)cyanato group in the iso(thio)cyanate compound (B), and the like.

[Polythiol Compound (C)]

The polymerizable composition for an optical material of the second embodiment preferably further contains a polythiol compound (C) including at least one selected from the group consisting of a dithiol compound (c1) containing two mercapto groups and a polythiol compound (c2) containing three or more mercapto groups.

Details of specific examples, preferred aspects, and preferred contents of the polythiol compound (C), the dithiol compound (c1), and the polythiol compound (c2) used in the polymerizable composition for an optical material of the second embodiment, a ratio (c1/c2) of a number of moles c1 of the mercapto groups of the dithiol compound (c1) to a number of moles c2 of the mercapto groups of the polythiol compound (c2), and the like are the same as the details of the specific examples, preferred aspects, and preferred contents of the polythiol compound (C), the dithiol compound (c1), and the polythiol compound (c2) described in the section of the first embodiment, the ratio (c1/c2) of the number of moles c1 of mercapto groups of the dithiol compound (c1) to a number of moles c2 of the mercapto groups of the polythiol compound (c2), and the like.

[Catalyst]

The polymerizable composition for an optical material of the second embodiment contains an organotin compound (D) and a tertiary amine compound (E) as catalysts.

The polymerizable composition for an optical material of the second embodiment may contain only one organotin compound (D) or two or more organotin compounds (D).

The polymerizable composition for an optical material of the second embodiment may contain only one tertiary amine compound (E) or two or more tertiary amine compound (E).

The polymerizable composition for an optical material of the second embodiment contains the organotin compound (D) and the tertiary amine compound (E) as catalysts, so that striae can be favorably suppressed in the resulting cured product.

(Organotin Compound (D))

The polymerizable composition for an optical material of the second embodiment contains the organotin compound (D) as a catalyst.

The organotin compound (D) can be used without particular limitation, and examples thereof include dialkyltin halides such as dibutyltin dichloride and dimethyltin dichloride, and dialkyltin dicarboxylates such as dimethyltin diacetate, dibutyltin dioctanoate, and dibutyltin dilaurate.

The dialkyltin halides may include monoalkyltin halides and trialkyltin halides. The dialkyltin dicarboxylates may include monoalkyltin tricarboxylates and trialkyltin carboxylates.

The organotin compound (D) preferably includes a compound represented by the following general formula (3).

(R₄)_{c}—Sn—X_{4-c} (3)

In general formula (3), R₄ represents an alkyl group having 1 to 4 carbon atoms; X represents a fluorine atom, a chlorine atom, a bromine atom or —O—C(═O)—R₅; R₅ represents an alkyl group having 1 to 11 carbon atoms; and c represents an integer from 1 to 3.

The compound represented by general formula (3) is preferably dimethyltin chloride, dibutyltin chloride, or dibutyltin dilaurate.

A content of the organotin compound (D) is preferably 100 ppm to 500 ppm, and more preferably 200 ppm to 400 ppm with respect to a total amount of the polymerizable composition for an optical material from the viewpoint of suppressing striae in the resulting cured product.

(Tertiary Amine Compound (E))

The polymerizable composition for an optical material of the second embodiment contains the tertiary amine compound (E) as a catalyst.

The tertiary amine compound (E) preferably includes a compound represented by the following general formula (4).

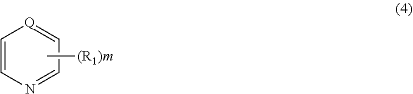

In general formula (4), R₁ represents a linear alkyl group having 1 to 20 carbon atoms, a branched alkyl group having 3 to 20 carbon atoms, a cycloalkyl group having 3 to 20 carbon atoms, or a halogen atom; a plurality of R₁'s may be the same or different; Q represents a carbon atom, a nitrogen atom, or an oxygen atom; and m represents an integer from 0 to 5.

R₁ is preferably a linear alkyl group having 1 to 20 carbon atoms or a halogen atom, and more preferably a linear alkyl group having 1 to 3 carbon atoms or a chlorine atom.

m is preferably an integer from 0 to 3, and more preferably an integer from 1 to 3.

Examples of the linear alkyl group having 1 to 20 carbon atoms represented as R₁ include a methyl group, an ethyl group, a n-propyl group, a n-butyl group, a pentyl group, a hexyl group, a heptyl group, a n-octyl group, a nonyl group, a decyl group, and a dodecyl group.

Examples of the branched alkyl group having 3 to 20 carbon atoms include an isopropyl group, an isobutyl group, a t-butyl group, an isopentyl group, an isooctyl group, a 2-ethylhexyl group, a 2-propylpentyl group, and an isodecyl group.

Examples of the cycloalkyl group having 3 to 20 carbon atoms include a cyclopropyl group, a cyclobutyl group, a cyclopentyl group, a cyclohexyl group, a cycloheptyl group, and a cyclooctyl group.

Examples of the compound represented by general formula (4) include 2-methylpyrazine, pyridine, α-picoline, β-picoline, γ-picoline, 2,6-lutidine, 3,5-lutidine, 2,4,6-trimethylpyridine, and 3-chlorpyridine.

Among the above, 3,5-lutidine is preferable.

As the tertiary amine compound (E), a compound represented by the following general formula (5) may be used.

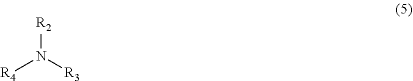

In general formula (5), each of R₂, R₃, and R₄ independently represents a linear alkyl group having 1 to 20 carbon atoms, a branched alkyl group having 3 to 20 carbon atoms, a cycloalkyl group having 3 to 20 carbon atoms, or an allyl group.

R₂, R₃, and R₄ are preferably each independently a linear alkyl group having 3 to 20 carbon atoms, more preferably each independently a linear alkyl group having 3 to 10 carbon atoms, and still more preferably each independently a linear alkyl group having 5 to 10 carbon atoms.

Examples of the linear alkyl group having 1 to 20 carbon atoms include a n-propyl group, a n-butyl group, a pentyl group, a hexyl group, a heptyl group, a n-octyl group, a nonyl group, a decyl group, and a dodecyl group.

Examples of the compound represented by general formula (5) can include trioctylamine and triallylamine.

In the polymerizable composition for an optical material of the second embodiment, it is preferable that the organotin compound (D) includes a compound represented by general formula (3), and that the tertiary amine compound (E) includes a compound represented by general formula (4).

In the polymerizable composition for an optical material of the second embodiment, it is preferable:
that the compound represented by general formula (3) is dimethyltin chloride, dibutyltin chloride, and dibutyltin dilaurate, and
that the compound represented by general formula (4) is 2-methylpyrazine, pyridine, α-picoline, β-picoline, γ-picoline, 2,6-lutidine, 3,5-lutidine, 2,4,6-trimethylpyridine, and 3-chlorpyridine.

[Polyol Compound (G)]

In the second embodiment, the polymerizable composition for an optical material may contain a polyol compound (G) containing two or more hydroxy groups as necessary. The polyol compound (G) is a dihydric (bifunctional) or higher polyhydric alcohol containing two or more hydroxy groups, in other words.

Details of the specific examples, preferred aspects, a preferred content and the like of the polyol compound (G) used in the polymerizable composition for an optical material of the second embodiment are the same as the details of the specific examples, preferred aspects, preferred content and the like of the polyol compound (G) described in the section of the first embodiment.

(Other Components)

The polymerizable composition for an optical material of the second embodiment may further contain additives such as an internal mold release agent, a resin modifier, a light stabilizer, a bluing agent, an ultraviolet absorber, an antioxidant, a coloring inhibitor, a dye, and a photochromic dye according to properties desired for the application to which the composition is to be applied.

Details of specific examples and preferred aspects of additives such as an internal mold release agent, a resin modifier, a light stabilizer, a bluing agent, an ultraviolet absorber, an antioxidant, a coloring inhibitor, a dye, and a photochromic dye used in the polymerizable composition for an optical material of the second embodiment are the same as the specific examples and preferred aspects of the additives such as the internal mold release agent, the resin modifier, the light stabilizer, the bluing agent, the ultraviolet absorber, the antioxidant, the coloring inhibitor, the dye, and the photochromic dye described in the section of the first embodiment.

<Method for Producing Polymerizable Composition for Optical Material>

The method for producing a polymerizable composition for an optical material according to the second embodiment includes:
a step (i) of obtaining an iso(thio)cyanate compound by reacting at least one amine compound (A) selected from the group consisting of an amine compound (a1) represented by general formula (1) and an amine compound (a2) represented by general formula (2) with an isocyanate compound (B) containing two or more iso(thio)cyanato groups; and
a step (ii) of mixing an organotin compound (D), a tertiary amine compound (E), the iso(thio)cyanate compound, and a polythiol compound (C) including at least one selected from the group consisting of a dithiol compound (c1) containing two mercapto groups and a polythiol compound (c2) containing three or more mercapto groups to produce a composition.

The polymerizable composition for an optical material of the second embodiment is prepared by a method in which an amine compound (A) and an iso(thio)cyanate compound (B) are reacted to obtain an iso(thio)cyanate compound, and then an organotin compound (D), a tertiary amine compound (E), an iso(thio)cyanate compound (B), a polythiol compound (C), and, optionally, other components are mixed.

The method for producing a polymerizable composition for an optical material is carried out by the above method, so that a cured product having suppressed striae can be suitably obtained.

Hereinafter, each step in the method for producing a polymerizable composition for an optical material of the second embodiment will be described.

[Step (i)]

Details of specific aspects, preferred aspects, and the like of the step (i) in the second embodiment are the same as the details of the specific aspects, preferred aspects, and the like of the step (i) in the first embodiment.

[Iso(thio)cyanate Compound]

A specific aspect of the iso(thio)cyanate compound in the second embodiment is the same as the specific aspect of the iso(thio)cyanate compound in the first embodiment.

<Mw/Mn>

The details of a preferred range of Mw/Mn value of the iso(thio)cyanate compound, a measurement method, and the like in the second embodiment are the same as the details of the preferred range of Mw/Mn value of the iso(thio)cyanate compound, the measurement method, and the like in the first embodiment.

The step (i) is preferably a step in which the amine compound (A) and the iso(thio)cyanate compound (B) are reacted under the condition that satisfies at least one of Condition 1 or Condition 2 to produce an iso(thio)cyanate compound.

Condition 1: a mixture of the amine compound (A) and the iso(thio)cyanate compound (B) is reacted by stirring at a stirring rate of 150 to 200 rpm (revolutions per minute), and the amine compound (A) and the iso(thio)cyanate compound (B) are reacted in a reaction device in which a ratio (D/d) of a reactor diameter (D) to a stirring blade diameter (d) is 3.0 or less,

Condition 2: a mixture of the amine compound (A) and the iso(thio)cyanate compound (B) is reacted by stirring at a stirring rate of 200 rpm or more.

Details of significance, specific aspects, preferred aspects, and the like of Conditions 1 and 2 in the second embodiment are the same as the details of significance, specific aspects, preferred aspects, and the like of Conditions 1 and 2 in the first embodiment.

[Step (ii)]

The step (ii) includes a step of mixing an organotin compound (D), a tertiary amine compound (E), the iso(thio)cyanate compound obtained in the step (i), and a polythiol compound (C) including at least one selected from the group consisting of a dithiol compound (c1) containing two mercapto groups and a polythiol compound (c2) containing three or more mercapto groups to produce a composition.

In the step (ii), by mixing the organotin compound (D), the tertiary amine compound (E), the iso(thio)cyanate compound, and the polythiol compound (C), striae of a cured product obtained from the polymerizable composition for an optical material can be favorably suppressed.

The details of specific aspects, preferred aspects, and the like of the step (ii) in the second embodiment are the same as the details of the specific aspects, preferred aspects, and the like of the step (ii) in the first embodiment, except that the organotin compound (D) and the tertiary amine compound (E) are further mixed in addition to the iso(thio)cyanate compound obtained in the step (i) and the polythiol compound (C).

In the second embodiment, the method for producing a polymerizable composition for an optical material may be:
a method in which after the iso(thio)cyanate compound of the second embodiment is obtained by the iso(thio)cyanate compound production step, a polythiol compound (C) is added to the iso(thio)cyanate compound, and then a polyol compound (G) is added to and mixed with the mixture;
a method in which after the iso(thio)cyanate compound of the second embodiment is obtained by the iso(thio)cyanate compound production step, a polyol compound (G) is added to the iso(thio)cyanate compound, and then a polythiol compound (C) is added to the mixture; or
a method in which after the iso(thio)cyanate compound of the second embodiment is obtained by the iso(thio)cyanate compound production step, a mixture of a polythiol compound (C) and a polyol compound (G) is added to the iso(thio)cyanate compound.

<Molded Body>

Details of aspects and the like of a molded body of the second embodiment are the same as the details of the aspects and the like of the molded body of the first embodiment.

<Optical Material>

Details of specific aspects, preferred aspects, production method, and the like of an optical material in the second embodiment are the same as the details of the specific aspects, preferred aspects, production method, and the like of the optical material in the first embodiment.

<Plastic Lens>

Details of specific aspects, preferred aspects, and the like of a plastic lens in the second embodiment are the same as the details of the specific aspects, preferred aspects, and the like of the plastic lens in the first embodiment.

<Plastic Spectacle Lens>

The optical material obtained by curing the polymerizable composition for an optical material of the second embodiment can be used as a plastic spectacle lens that is a lens substrate for a spectacle lens.

Details of specific aspects, preferred aspects, production method, and the like of a plastic spectacle lens in the second embodiment are the same as the details of the specific aspects, preferred aspects, production method, and the like of the plastic spectacle lens in the first embodiment.

<Plastic Polarizing Lens>

The optical material obtained by curing the polymerizable composition for an optical material of the second embodiment can be used as a plastic polarizing lens that is a lens substrate for a plastic polarizing lens.

Details of specific aspects, preferred aspects, production method, and the like of a plastic polarizing lens in the second embodiment are the same as the details of the specific aspects, preferred aspects, production method, and the like of the plastic polarizing lens in the first embodiment.

<Application>

Details of specific examples and the like of an application of the optical material of the second embodiment are the same as the details of the specific examples and the like of the application of the optical material of the first embodiment.

Although the second embodiment has been described above with reference to the embodiment, the second embodiment is not limited to the above-described embodiment, and various aspects can be taken without impairing the effects of the present invention.

The second embodiment also includes the following aspects.

<2-1> A polymerizable composition for an optical material containing an amine compound (A) including at least one selected from the group consisting of a compound (a1) represented by the following general formula (1) and a compound (a2) represented by the following general formula (2), a bi- or higher-functional iso(thio)cyanate compound (B), a polythiol compound (C) including at least one selected from the group consisting of a dithiol compound (c1) containing two mercapto groups and a polythiol compound (c2) containing three or more mercapto groups, an organotin compound (D), and a tertiary amine compound (E).

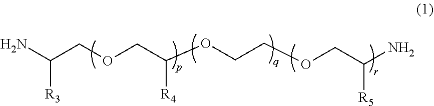

In general formula (1), each of R₃ to R₅ independently represents a hydrogen atom or a methyl group. p represents an integer from 0 to 100; q represents an integer from 0 to 100; r represents an integer from 0 to 100; and p+r equals an integer from 1 to 100. When a plurality of R₄ is present, respective R₄'s may be the same as or different from each other. When a plurality of R₅ is present, respective R₅'s may be the same as or different from each other.

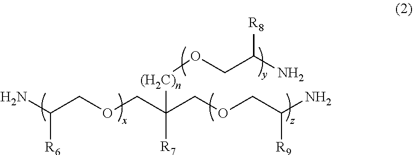

In general formula (2), each of R₆, R₈ and R₉ independently represents a hydrogen atom or a methyl group. R₇ represents a linear alkyl group having 1 to 20 carbon atoms, a branched alkyl group having 3 to 20 carbon atoms, or a cyclic alkyl group having 3 to 20 carbon atoms. x represents an integer from 0 to 200; y represents an integer from 0 to 200; z represents an integer from 0 to 200; and x+y+z equals an integer from 1 to 200. n represents an integer from 0 to 10. When a plurality of R₆ is present, respective R₆'s may be the same as or different from each other. When a plurality of R₈ is present, respective R₈'s may be the same as or different from each other. When a plurality of R₉ is present, respective R₉'s may be the same as or different from each other.

<2-2> The polymerizable composition for an optical material according to <2-1>, wherein the organotin compound (D) includes a compound represented by the following general formula (3), and the tertiary amine compound (E) includes a compound represented by the following general formula (4).

(R₄)_{c}—Sn—X_{4-c} (3)

In general formula (3), R₄ represents an alkyl group having 1 to 4 carbon atoms; X represents a fluorine atom, a chlorine atom, a bromine atom or —O—C(═O)—R₅; R₅ represents an alkyl group having 1 to 11 carbon atoms; and c represents an integer from 1 to 3.

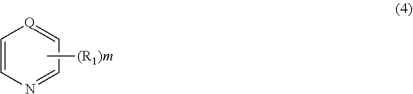

In general formula (4), R₁ represents a linear alkyl group having 1 to 20 carbon atoms, a branched alkyl group having 3 to 20 carbon atoms, a cycloalkyl group having 3 to 20 carbon atoms, or a halogen atom; a plurality of R₁'s may be the same or different; Q represents a carbon atom, a nitrogen atom, or an oxygen atom; and m represents an integer from 0 to 5.

<2-3> The polymerizable composition for an optical material according to <2-2>, wherein the compound represented by the general formula (3) is dimethyltin chloride, dibutyltin chloride, and dibutyltin dilaurate, and the compound represented by the general formula (4) is 2-methylpyrazine, pyridine, α-picoline, β-picoline, γ-picoline, 2,6-lutidine, 3,5-lutidine, 2,4,6-trimethylpyridine, and 3-chlorpyridine.

<2-4> The polymerizable composition for an optical material according to any one of <2-1> to <2-3>, wherein a content of the organotin compound (D) is 100 ppm to 500 ppm with respect to a total amount of the polymerizable composition for an optical material.

<2-5> The polymerizable composition for an optical material according to any one of <2-1> to <2-4>, wherein a ratio (a/b) of a number of moles a of an amino group in the amine compound (A) to a number of moles b of an iso(thio)cyanato group in the iso(thio)cyanate compound (B) is less than 1.0.

<2-6> The polymerizable composition for an optical material according to any one of <2-1> to <2-5>, wherein the amine compound (A) includes the compound (a1) represented by the general formula (1), and a weight average molecular weight (Mw) of the compound (a1) represented by the general formula (1) is from 100 to 4000.

<2-7> The polymerizable composition for an optical material according to any one of <2-1> to <2-6>, wherein the amine compound (A) includes the compound (a2) represented by the general formula (2), and a weight average molecular weight (Mw) of the compound (a2) represented by the general formula (2) is from 100 to 5000.

<2-8> The polymerizable composition for an optical material according to any one of <2-1> to <2-7>, wherein the iso(thio)cyanate compound (B) is at least one selected from the group consisting of hexamethylene diisocyanate, pentamethylene diisocyanate, xylylene diisocyanate, isophorone diisocyanate, bis(isocyanatomethyl)cyclohexane, dicyclohexylmethane-4,4′-diisocyanate, 2,5-bis(isocyanatomethyl)bicyclo-[2.2.1]-heptane, 2,6-bis(isocyanatomethyl)bicyclo-[2.2.1]-heptane, tolylene diisocyanate, phenylene diisocyanate, and 4,4′-diphenylmethane diisocyanate.

<2-9> The polymerizable composition for an optical material according to any one of <2-1> to <2-8>, wherein the polythiol compound (C) includes both the dithiol compound (c1) and the polythiol compound (c2), and a ratio (c1/c2) of a number of moles c1 of the mercapto groups of the dithiol compound (c1) to a number of moles c2 of the mercapto groups in the polythiol compound (c2) is in a range of from 1 to 13.

<2-10> The polymerizable composition for an optical material according to any one of <2-1> to <2-9>, wherein
the dithiol compound (c1) is at least one selected from the group consisting of 2,5-dimercaptomethyl-1,4-dithiane, ethylene glycol bis(3-mercaptopropionate), 4,6-bis(mercaptomethylthio)-1,3-dithiane, 2-(2,2-bis(mercaptomethylthio)ethyl)-1,3-dithietane, and bis(2-mercaptoethyl)sulfide, and
the polythiol compound (c2) is at least one selected from the group consisting of trimethylolpropane tris(3-mercaptopropionate), pentaerythritol tetrakis(2-mercaptoacetate), pentaerythritol tetrakis(3-mercaptopropionate), 4-mercaptomethyl-1,8-dimercapto-3,6-dithiaoctane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, and 1,1,3,3-tetrakis(mercaptomethylthio)propane.

<2-11> A molded body obtained by curing the polymerizable composition for an optical material according to any one of <2-1> to <2-10>.

<2-12> An optical material including the molded body according to <2-11>.

<2-13> A plastic lens including the molded body according to <2-11>.

<2-14> A plastic polarizing lens including: a substrate layer including the molded body according to <2-11>; and a polarizing film.

<2-15> A method for producing a polymerizable composition for an optical material, the method including:
a step (i) of obtaining an iso(thio)cyanate compound by reacting at least one amine compound (A) selected from the group consisting of an amine compound (a1) represented by the following general formula (1) and an amine compound (a2) represented by the following general formula (2) with an isocyanate compound (B) containing two or more iso(thio)cyanato groups; and
a step (ii) of mixing an organotin compound (D), a tertiary amine compound (E), the iso(thio)cyanate compound, and a polythiol compound (C) including at least one selected from the group consisting of a dithiol compound (c1) containing two mercapto groups and a polythiol compound (c2) containing three or more mercapto groups to produce a composition.

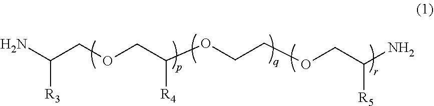

In general formula (1), each of R₃ to R₅ independently represents a hydrogen atom or a methyl group. p represents an integer from 0 to 100; q represents an integer from 0 to 100; r represents an integer from 0 to 100; and p+r equals an integer from 1 to 100. When a plurality of R₄ is present, respective R₄'s may be the same as or different from each other. When a plurality of R₅ is present, respective R₅'s may be the same as or different from each other.

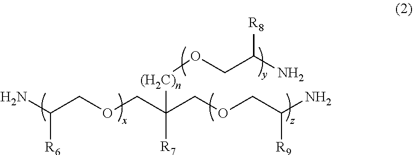

In general formula (2), each of R₆, R₈ and R₉ independently represents a hydrogen atom or a methyl group. R₇ represents a linear alkyl group having 1 to 20 carbon atoms, a branched alkyl group having 3 to 20 carbon atoms, or a cyclic alkyl group having 3 to 20 carbon atoms. x represents an integer from 0 to 200; y represents an integer from 0 to 200; z represents an integer from 0 to 200; and x+y+z equals an integer from 1 to 200. n represents an integer from 0 to 10. When a plurality of R₆ is present, respective R₆'s may be the same as or different from each other. When a plurality of R₈ is present, respective R₈'s may be the same as or different from each other. When a plurality of R₉ is present, respective R₉'s may be the same as or different from each other.

<2-16> A method for producing an optical material, the method including: a step of injecting the polymerizable composition for an optical material according to any one of <2-1> to <2-10> into a mold; and a step of polymerizing and curing the polymerizable composition for an optical material in the mold.

<2-17> A method for producing a plastic polarizing lens, the method including: a step of disposing a polarizing film in a mold; a step of injecting the polymerizable composition for an optical material according to any one of <2-1> to <2-10> into the mold in which the polarizing film is disposed; and a step of polymerizing and curing the polymerizable composition for an optical material to obtain a plastic polarizing lens including: a substrate layer including a molded body obtained by curing the polymerizable composition for an optical material; and a polarizing film.

### Third Embodiment

<<Polymerizable Composition for Optical Material>>

The polymerizable composition for an optical material of the third embodiment contains an amine compound (A) including at least one selected from the group consisting of a compound (a1) represented by the following general formula (1) and a compound (a2) represented by the following general formula (2), a bi- or higher-functional iso(thio)cyanate compound (B), a polythiol compound (C) including at least one selected from the group consisting of a dithiol compound (c1) containing two mercapto groups and a polythiol compound (c2) containing three or more mercapto groups, and an ultraviolet absorber (F) having a maximum absorption peak in a range of from 350 nm to 370 nm and including a compound represented by the following general formula (6).

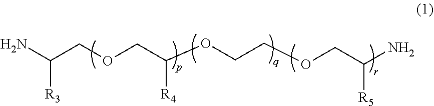

In general formula (1), each of R₃ to R₅ independently represents a hydrogen atom or a methyl group. p represents an integer from 0 to 100; q represents an integer from 0 to 100; r represents an integer from 0 to 100; and p+r equals an integer from 1 to 100. When a plurality of R₄ is present, respective R₄'s may be the same as or different from each other. When a plurality of R₅ is present, respective R₅'s may be the same as or different from each other.

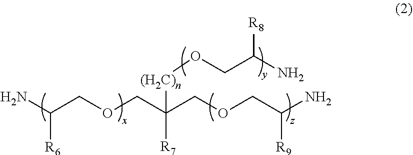

In general formula (2), each of R₆, R₈ and R₉ independently represents a hydrogen atom or a methyl group. R₇ represents a linear alkyl group having 1 to 20 carbon atoms, a branched alkyl group having 3 to 20 carbon atoms, or a cyclic alkyl group having 3 to 20 carbon atoms. x represents an integer from 0 to 200; y represents an integer from 0 to 200; z represents an integer from 0 to 200; and x+y+z equals an integer from 1 to 200. n represents an integer from 0 to 10. When a plurality of R₆ is present, respective R₆'s may be the same as or different from each other. When a plurality of R₈ is present, respective R₈'s may be the same as or different from each other. When a plurality of R₉ is present, respective R₉'s may be the same as or different from each other.

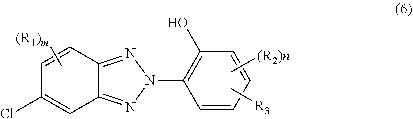

In general formula (6), each of R₁ and R₂ independently represents an alkyl group having 1 to 8 carbon atoms. When a plurality of R₁ is present, respective R₁'s may be the same as or different from each other. When a plurality of R₂ is present, respective R₂'s may be the same as or different from each other. R₃ represents a functional group having 2 to 15 carbon atoms and containing an ester bond. m represents an integer from 0 to 3; and n represents an integer from 0 to 3.

The polymerizable composition for an optical material of the third embodiment includes the above configuration, so that a cured product excellent in light blocking properties against light having a wavelength of 400 nm can be obtained.

In one embodiment of the polymerizable composition for an optical material of the third embodiment, it is also possible to obtain a cured product excellent in light blocking properties against light having a wavelength of 400 nm while maintaining impact resistance and heat resistance.

Hereinafter, each component of the polymerizable composition for an optical material of the third embodiment will be described.

[Amine Compound (A)]

Details of the structure, specific examples, preferred aspects, a preferred content and the like of the amine compound (A) used in the polymerizable composition for an optical material of the third embodiment are the same as the details of the structure, specific examples, preferred aspects, preferred content and the like of the amine compound (A) described in the section of the first embodiment.

[Iso(thio)cyanate Compound (B)]

The iso(thio)cyanate compound (B) used in the polymerizable composition for an optical material of the third embodiment is a bi- or higher-functional iso(thio)cyanate compound.

Details of specific examples, preferred aspects, and a preferred content of the iso(thio)cyanate compound (B) used in the polymerizable composition for an optical material of the third embodiment, a ratio (a/b) of a number of moles a of an amino group of the amine compound (A) to a number of moles b of an iso(thio)cyanato group of the iso(thio)cyanate compound (B), a ratio ((a+c)/b) of a total number of moles (a+c) of the number of moles a of the amino group in the amine compound (A) and a number of moles c of mercapto groups in a polythiol compound (C) to the number of moles b of the iso(thio)cyanato group in the iso(thio)cyanate compound (B), and the like are the same as the details of the specific examples, preferred aspects, and preferred content of the iso(thio)cyanate compound (B) described in the section of the first embodiment, ratio (a/b) of the number of moles a of the amino group of the amine compound (A) to the number of moles b of the iso(thio)cyanato group of the iso(thio)cyanate compound (B), ratio ((a+c)/b) of the total number of moles (a+c) of the number of moles a of the amino group in the amine compound (A) and the number of moles c of the mercapto groups in the polythiol compound (C) to the number of moles b of the iso(thio)cyanato group in the iso(thio)cyanate compound (B), and the like.

[Polythiol Compound (C)]

The polymerizable composition for an optical material of the third embodiment preferably further contains a polythiol compound (C) including at least one selected from the group consisting of a dithiol compound (c1) containing two mercapto groups and a polythiol compound (c2) containing three or more mercapto groups.

Details of specific examples, preferred aspects, and preferred contents of the polythiol compound (C), the dithiol compound (c1), and the polythiol compound (c2) used in the polymerizable composition for an optical material of the third embodiment, a ratio (c1/c2) of a number of moles c1 of the mercapto groups of the dithiol compound (c1) to a number of moles c2 of the mercapto groups of the polythiol compound (c2), and the like are the same as the details of the specific examples, preferred aspects, and preferred contents of the polythiol compound (C), the dithiol compound (c1), and the polythiol compound (c2) described in the section of the first embodiment, the ratio (c1/c2) of the number of moles c1 of mercapto groups of the dithiol compound (c1) to a number of moles c2 of the mercapto groups of the polythiol compound (c2), and the like.

(Ultraviolet Absorber (F))

The polymerizable composition for an optical material of the third embodiment contains an ultraviolet absorber (F).

The ultraviolet absorber (F) has a maximum absorption peak in a range of from 350 nm to 370 nm and includes a compound represented by the following general formula (6).

The polymerizable composition for an optical material of the third embodiment contains the ultraviolet absorber (F), so that it is possible to obtain a cured product excellent in light blocking properties against light having a wavelength of 400 nm while maintaining impact resistance and heat resistance, and the productivity of optical materials is excellent.

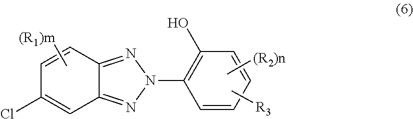

In general formula (6), each of R₁ and R₂ independently represents an alkyl group having 1 to 8 carbon atoms. When a plurality of R₁ is present, respective R₁'s may be the same as or different from each other. When a plurality of R₂ is present, respective R₂'s may be the same as or different from each other. R₃ represents a functional group having 2 to 15 carbon atoms and containing an ester bond. m represents an integer from 0 to 3; and n represents an integer from 0 to 3.

In general formula (6), each of R₁ and R₂ independently represents an alkyl group having 1 to 8 carbon atoms, and preferably each of R₁ and R₂ independently represents an alkyl group having 2 to 6 carbon atoms.

In general formula (6), m represents an integer from 0 to 3, and is preferably 0 or 1.

In general formula (6), n represents an integer from 0 to 3, and is preferably 1 or 2.

In general formula (6), R₃ represents a functional group having 2 to 15 carbon atoms and containing an ester bond, and is preferably —R₄—C(═O)OR₅ or —R₄—OC(═O)—R₅, and more preferably —R₄—C(═O)OR₅. Each of R₄ and R₅ independently represents an optionally branched hydrocarbon group having 1 to 10 carbon atoms. More specifically, R₄ represents an optionally branched divalent hydrocarbon group having 1 to 10 carbon atoms, and R₅ represents an optionally branched monovalent hydrocarbon group having 1 to 10 carbon atoms.

The ultraviolet absorber (F) preferably has a maximum absorption peak in a range of from 350 nm to 370 nm and includes a compound represented by the following general formula (6-1).

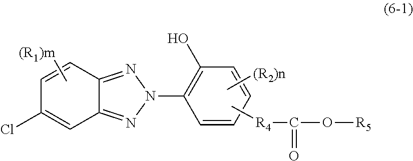

In general formula (6-1), each of R₁ and R₂ independently represents an alkyl group having 1 to 8 carbon atoms. When a plurality of R₁ is present, respective R₁'s may be the same as or different from each other. When a plurality of R₂ is present, respective R₂'s may be the same as or different from each other. Each of R₄ and R₅ independently represents an optionally branched hydrocarbon group having 1 to 10 carbon atoms. m represents an integer from 0 to 3; and n represents an integer from 0 to 3.

In general formula (6-1), R₄ represents an optionally branched hydrocarbon group having 1 to 10 carbon atoms, and preferably represents an optionally branched alkylene group having 1 to 5 carbon atoms.

In general formula (6-1), R₅ represents an optionally branched hydrocarbon group having 1 to 10 carbon atoms, and preferably represents an optionally branched alkyl group having 3 to 10 carbon atoms.

The ultraviolet absorber (F) more preferably has a maximum absorption peak in a range of from 350 nm to 370 nm and includes a compound represented by the following general formula (6-2).

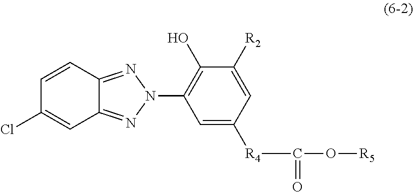

In general formula (6-2), R₂, R₄ and R₅ have the same meanings as R₂, R₄ and R₅ in general formula (6-1).

The ultraviolet absorber (F) still more preferably has a maximum absorption peak in a range of from 350 nm to 370 nm and includes a compound represented by the following general formula.

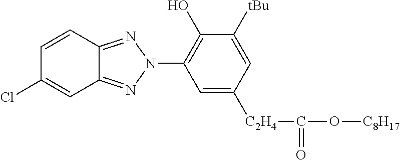

Examples of the ultraviolet absorber (F) include a mixture of octyl-3-[3-tert-butyl-4-hydroxy-5-(5-chloro-2H-benzotriazole-2-yl) phenyl]propionate and 2-ethylhexyl-3-[3-tert-butyl-4-hydroxy-5-(5-chloro-2H-benzotriazole-2-yl)phenyl]propionate, and EVERSORB 109 (manufactured by EVERLIGHT CHEMICAL) and the like can be used. When these ultraviolet absorbers are used, the solubility in the polymerizable composition may be able to be improved as compared with an ultraviolet absorber having a similar chlorobenzotriazole structure, such as Tinuvin 326 (2-(5-chloro-2H-benzotriazole-2-yl)-4-methyl-6-tert-butylphenol). In addition, yellowing of the cured product by the ultraviolet absorber may be able to be suppressed.

From the viewpoint of the effects in the third embodiment, the ultraviolet absorber (F) may be contained in an amount of 0.01 mass % or more, is contained in an amount of preferably 0.05 mass % or more, and more preferably 0.10 mass % or more, based on 100 mass % of the polymerizable composition for an optical material.

Also, the ultraviolet absorber (F) may be contained in an amount of 10.00 mass % or less, is contained in an amount of preferably 2.00 mass % or less, and more preferably 1.00 mass % or less, based on 100 mass % of the polymerizable composition for an optical material.

From the viewpoint of the effects in the third embodiment, the ultraviolet absorber (F) may be contained in an amount of 0.01 mass % to 10.00 mass %, is contained in an amount of preferably 0.05 mass % to 2.00 mass %, and more preferably 0.10 mass % to 1.00 mass %, based on 100 mass % of the polymerizable composition for an optical material.

The ultraviolet absorber (F) is excellent in solubility and dispersibility in the isocyanate compound (A) and the active hydrogen compound (B), and can be easily added by mixing and stirring them.

Since the ultraviolet absorber (F) is excellent in solubility and dispersibility in the isocyanate compound (A) and the active hydrogen compound (B), a uniform polymerizable composition can be obtained in a short time, and productivity is excellent.

Furthermore, since the ultraviolet absorber (F) is excellent in solubility and dispersibility, a large amount of the ultraviolet absorber (F) can be added, and even when the ultraviolet absorber (F) is added in a large amount, the ultraviolet absorber (F) does not bleed out from the optical material, so that cloudiness or the like is less likely to occur. Therefore, by using the ultraviolet absorber (F), it is easy to control a wavelength cut rate depending on the amount thereof to be added.

In addition, in the third embodiment, from the viewpoint of improving the light blocking properties against light having a wavelength of 400 nm while maintaining impact resistance and heat resistance, the compound represented by general formula (6) is preferably the compound represented by general formula (6-1), more preferably the compound represented by general formula (6-2), and still more preferably at least one selected from the group consisting of octyl-3-[3-tert-butyl-4-hydroxy-5-(5-chloro-2H-benzotriazole-2-yl) phenyl]propionate and 2-ethylhexyl-3-[3-tert-butyl-4-hydroxy-5-(5-chloro-2H-benzotriazole-2-yl)phenyl]propionate.

The polymerizable composition for an optical material of the third embodiment may contain an ultraviolet absorber other than the ultraviolet absorber (F).

Examples of such other ultraviolet absorbers can include benzophenone-based compounds, triazine compounds, and benzotriazole-based compounds.

[Polyol Compound (G)]

In the third embodiment, the polymerizable composition for an optical material may contain a polyol compound (G) containing two or more hydroxy groups as necessary. The polyol compound (G) is a dihydric (bifunctional) or higher polyhydric alcohol containing two or more hydroxy groups, in other words.

Details of the specific examples, preferred aspects, a preferred content and the like of the polyol compound (G) used in the polymerizable composition for an optical material of the third embodiment are the same as the details of the specific examples, preferred aspects, preferred content and the like of the polyol compound (G) described in the section of the first embodiment.

(Other Components)

The polymerizable composition for an optical material of the third embodiment may further contain additives such as a polymerization catalyst, an internal mold release agent, a resin modifier, a light stabilizer, a bluing agent, an antioxidant, a coloring inhibitor, a dye, and a photochromic dye according to properties desired for the application to which the composition is to be applied.

Details of specific examples and preferred aspects of additives such as a polymerization catalyst, an internal mold release agent, a resin modifier, a light stabilizer, a bluing agent, an antioxidant, a coloring inhibitor, a dye, and a photochromic dye used in the polymerizable composition for an optical material of the third embodiment are the same as the specific examples and preferred aspects of the additives such as the polymerization catalyst, the internal mold release agent, the resin modifier, the light stabilizer, the bluing agent, the antioxidant, the coloring inhibitor, the dye, and the photochromic dye described in the section of the first embodiment.

<Method for Producing Polymerizable Composition for Optical Material>

The method for producing a polymerizable composition for an optical material according to the third embodiment includes: a step (i) of producing an iso(thio)cyanate compound by reacting at least one amine compound (A) selected from the group consisting of an amine compound (a1) represented by general formula (1) and an amine compound (a2) represented by general formula (2) with an isocyanate compound (B) containing two or more iso(thio)cyanato groups; and a step (ii) of mixing an ultraviolet absorber (F) having a maximum absorption peak in a range of from 350 nm to 370 nm and including a compound represented by the following general formula (6), the iso(thio)cyanate compound, and a polythiol compound (C) including at least one selected from the group consisting of a dithiol compound (c1) containing two mercapto groups and a polythiol compound (c2) containing three or more mercapto groups to produce a composition.

The polymerizable composition for an optical material of the third embodiment is prepared by a method in which an amine compound (A) and an iso(thio)cyanate compound (B) are reacted to obtain an iso(thio)cyanate compound, and then an ultraviolet absorber (F), an iso(thio)cyanate compound (B), a polythiol compound (C), and, optionally, other components are mixed.

The method for producing a polymerizable composition for an optical material is carried out by the above method, so that it is possible to obtain a cured product excellent in light blocking properties against light having a wavelength of 400 nm while maintaining impact resistance and heat resistance.

Hereinafter, each step in the method for producing a polymerizable composition for an optical material of the third embodiment will be described.

[Step (i)]

Details of specific aspects, preferred aspects, and the like of the step (i) in the third embodiment are the same as the details of the specific aspects, preferred aspects, and the like of the step (i) in the first embodiment.

[Iso(thio)cyanate Compound]

A specific aspect of the iso(thio)cyanate compound in the third embodiment is the same as the specific aspect of the iso(thio)cyanate compound in the first embodiment.

<Mw/Mn>

The details of a preferred range of Mw/Mn value of the iso(thio)cyanate compound, a measurement method, and the like in the third embodiment are the same as the details of the preferred range of Mw/Mn value of the iso(thio)cyanate compound, the measurement method, and the like in the first embodiment.

The step (i) is preferably a step in which the amine compound (A) and the iso(thio)cyanate compound (B) are reacted under the condition that satisfies at least one of Condition 1 or Condition 2 to produce an iso(thio)cyanate compound.

Condition 1: a mixture of the amine compound (A) and the iso(thio)cyanate compound (B) is reacted by stirring at a stirring rate of 150 to 200 rpm (revolutions per minute), and the amine compound (A) and the iso(thio)cyanate compound (B) are reacted in a reaction device in which a ratio (D/d) of a reactor diameter (D) to a stirring blade diameter (d) is 3.0 or less,

Condition 2: a mixture of the amine compound (A) and the iso(thio)cyanate compound (B) is reacted by stirring at a stirring rate of 200 rpm or more.

Details of significance, specific aspects, preferred aspects, and the like of Conditions 1 and 2 in the third embodiment are the same as the details of significance, specific aspects, preferred aspects, and the like of Conditions 1 and 2 in the first embodiment.

[Step (ii)]

The step (ii) includes a step of mixing an ultraviolet absorber (F), the iso(thio)cyanate compound obtained in the step (i), and a polythiol compound (C) including at least one selected from the group consisting of a dithiol compound (c1) containing two mercapto groups and a polythiol compound (c2) containing three or more mercapto groups to produce a composition.

The details of specific aspects, preferred aspects, and the like of the step (ii) in the third embodiment are the same as the details of the specific aspects, preferred aspects, and the like of the step (ii) in the first embodiment, except that the ultraviolet absorber (F) is further mixed in addition to the iso(thio)cyanate compound obtained in the step (i) and the polythiol compound (C).

In the third embodiment, the method for producing a polymerizable composition for an optical material may be:
a method in which after the iso(thio)cyanate compound of the third embodiment is obtained by the iso(thio)cyanate compound production step, a polythiol compound (C) is added to the iso(thio)cyanate compound, and then a polyol compound (G) is added to and mixed with the mixture;
a method in which after the iso(thio)cyanate compound of the third embodiment is obtained by the iso(thio)cyanate compound production step, a polyol compound (G) is added to the iso(thio)cyanate compound, and then a polythiol compound (C) is added to the mixture; or
a method in which after the iso(thio)cyanate compound of the third embodiment is obtained by the iso(thio)cyanate compound production step, a mixture of a polythiol compound (C) and a polyol compound (G) is added to the iso(thio)cyanate compound.

<Molded Body>

Details of aspects and the like of a molded body of the third embodiment are the same as the details of the aspects and the like of the molded body of the first embodiment.

<Optical Material>

Details of specific aspects, preferred aspects, production method, and the like of an optical material in the third embodiment are the same as the details of the specific aspects, preferred aspects, production method, and the like of the optical material in the first embodiment.

<Plastic Lens>

Details of specific aspects, preferred aspects, and the like of a plastic lens in the third embodiment are the same as the details of the specific aspects, preferred aspects, and the like of the plastic lens in the first embodiment.

<Plastic Spectacle Lens>

The optical material obtained by curing the polymerizable composition for an optical material of the third embodiment can be used as a plastic spectacle lens that is a lens substrate for a spectacle lens.

Details of specific aspects, preferred aspects, production method, and the like of a plastic spectacle lens in the third embodiment are the same as the details of the specific aspects, preferred aspects, production method, and the like of the plastic spectacle lens in the first embodiment.

<Plastic Polarizing Lens>

The optical material obtained by curing the polymerizable composition for an optical material of the third embodiment can be used as a plastic polarizing lens that is a lens substrate for a plastic polarizing lens.

Details of specific aspects, preferred aspects, production method, and the like of a plastic polarizing lens in the third embodiment are the same as the details of the specific aspects, preferred aspects, production method, and the like of the plastic polarizing lens in the first embodiment.

<Application>

Details of specific examples and the like of an application of the optical material of the third embodiment are the same as the details of the specific examples and the like of the application of the optical material of the first embodiment.

Although the third embodiment has been described above with reference to the embodiment, the third embodiment is not limited to the above-described embodiment, and various aspects can be taken without impairing the effects of the third embodiment.

The third embodiment also includes the following aspects.

<3-1> A polymerizable composition for an optical material containing an amine compound (A) including at least one selected from the group consisting of a compound (a1) represented by the following general formula (1) and a compound (a2) represented by the following general formula (2), a bi- or higher-functional iso(thio)cyanate compound (B), a polythiol compound (C) including at least one selected from the group consisting of a dithiol compound (c1) containing two mercapto groups and a polythiol compound (c2) containing three or more mercapto groups, and an ultraviolet absorber (F) having a maximum absorption peak in a range of from 350 nm to 370 nm and including a compound represented by the following general formula (6).

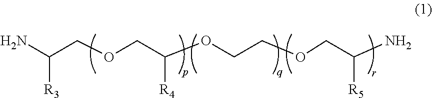

In general formula (1), each of R₃ to R₅ independently represents a hydrogen atom or a methyl group. p represents an integer from 0 to 100; q represents an integer from 0 to 100; r represents an integer from 0 to 100; and p+r equals an integer from 1 to 100. When a plurality of R₄ is present, respective R₄'s may be the same as or different from each other. When a plurality of R₅ is present, respective R₅'s may be the same as or different from each other.

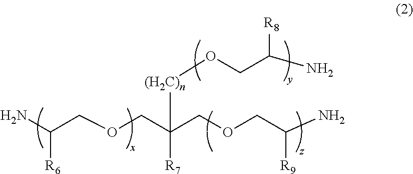

In general formula (2), each of R₆, R₈ and R₉ independently represents a hydrogen atom or a methyl group. R₇ represents a linear alkyl group having 1 to 20 carbon atoms, a branched alkyl group having 3 to 20 carbon atoms, or a cyclic alkyl group having 3 to 20 carbon atoms. x represents an integer from 0 to 200; y represents an integer from 0 to 200; z represents an integer from 0 to 200; and x+y+z equals an integer from 1 to 200. n represents an integer from 0 to 10. When a plurality of R₆ is present, respective R₆'s may be the same as or different from each other. When a plurality of R₈ is present, respective R₈'s may be the same as or different from each other. When a plurality of R₉ is present, respective R₉'s may be the same as or different from each other.

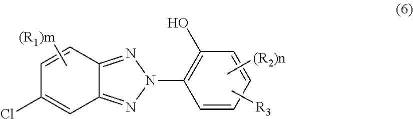

In general formula (6), each of R₁ and R₂ independently represents an alkyl group having 1 to 8 carbon atoms. When a plurality of R₁ is present, respective R₁'s may be the same as or different from each other. When a plurality of R₂ is present, respective R₂'s may be the same as or different from each other. R₃ represents a functional group having 2 to 15 carbon atoms and containing an ester bond. m represents an integer from 0 to 3; and n represents an integer from 0 to 3.

<3-2> The polymerizable composition for an optical material according to <3-1>, wherein the ultraviolet absorber (F) has a maximum absorption peak in a range of from 350 nm to 370 nm and includes a compound represented by the following general formula (6-1).

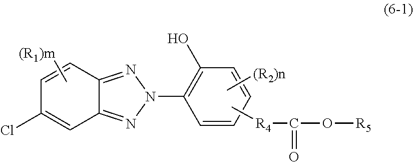

In general formula (6-1), each of R₁ and R₂ independently represents an alkyl group having 1 to 8 carbon atoms. When a plurality of R₁ is present, respective R₁'s may be the same as or different from each other. When a plurality of R₂ is present, respective R₂'s may be the same as or different from each other. Each of R₄ and R₅ independently represents an optionally branched hydrocarbon group having 1 to 10 carbon atoms. m represents an integer from 0 to 3; and n represents an integer from 0 to 3.

<3-3> The polymerizable composition for an optical material according to <3-1> or <3-2>, wherein a ratio (a/b) of a number of moles a of an amino group in the amine compound (A) to a number of moles b of an iso(thio)cyanato group in the iso(thio)cyanate compound (B) is less than 1.0.

<3-4> The polymerizable composition for an optical material according to any one of <3-1> to <3-3>, wherein the amine compound (A) includes the compound (a1) represented by the general formula (1), and a weight average molecular weight (Mw) of the compound (a1) represented by the general formula (1) is from 100 to 4000.

<3-5> The polymerizable composition for an optical material according to any one of <3-1> to <3-4>, wherein the amine compound (A) includes the compound (a2) represented by the general formula (2), and a weight average molecular weight (Mw) of the compound (a2) represented by the general formula (2) is from 100 to 5000.

<3-6> The polymerizable composition for an optical material according to any one of <3-1> to <3-5>, wherein the iso(thio)cyanate compound (B) is at least one selected from the group consisting of hexamethylene diisocyanate, pentamethylene diisocyanate, xylylene diisocyanate, isophorone diisocyanate, bis(isocyanatomethyl)cyclohexane, dicyclohexylmethane-4,4′-diisocyanate, 2,5-bis(isocyanatomethyl)bicyclo-[2.2.1]-heptane, 2,6-bis(isocyanatomethyl)bicyclo-[2.2.1]-heptane, tolylene diisocyanate, phenylene diisocyanate, and 4,4′-diphenylmethane diisocyanate.

<3-7> The polymerizable composition for an optical material according to any one of <3-1> to <3-6>, wherein the polythiol compound (C) includes both the dithiol compound (c1) and the polythiol compound (c2), and a ratio (c1/c2) of a number of moles c1 of the mercapto groups of the dithiol compound (c1) to a number of moles c2 of the mercapto groups in the polythiol compound (c2) is in a range of from 1 to 13.

<3-8> The polymerizable composition for an optical material according to any one of <3-1> to <3-7>, wherein
the dithiol compound (c1) is at least one selected from the group consisting of 2,5-dimercaptomethyl-1,4-dithiane, ethylene glycol bis(3-mercaptopropionate), 4,6-bis(mercaptomethylthio)-1,3-dithiane, 2-(2,2-bis(mercaptomethylthio)ethyl)-1,3-dithietane, and bis(2-mercaptoethyl)sulfide, and
the polythiol compound (c2) is at least one selected from the group consisting of trimethylolpropane tris(3-mercaptopropionate), pentaerythritol tetrakis(2-mercaptoacetate), pentaerythritol tetrakis(3-mercaptopropionate), 4-mercaptomethyl-1,8-dimercapto-3,6-dithiaoctane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, and 1,1,3,3-tetrakis(mercaptomethylthio)propane.

<3-9> A molded body obtained by curing the polymerizable composition for an optical material according to any one of <3-1> to <3-8>.

<3-10> A molded body obtained by curing a polymerizable composition for an optical material containing an amine compound (A), the composition containing at least one selected from the group consisting of a compound (a1) represented by the following general formula (1) and a compound (a2) represented by the following general formula (2), a bi- or higher-functional iso(thio)cyanate compound (B), a polythiol compound (C) including at least one selected from the group consisting of a dithiol compound (c1) containing two mercapto groups and a polythiol compound (c2) containing three or more mercapto groups, and an ultraviolet absorber (F) having a maximum absorption peak in a range of from 350 nm to 370 nm and including a compound represented by the following general formula (6), the molded body having a cut rate of 90% or more at a wavelength of 400 nm as measured with a flat plate having a thickness of 2.5 mm.

<3-11> An optical material including the molded body according to <3-9> or <3-10>.

<3-12> A plastic lens including the molded body according to <3-9> or <3-10>.

<3-13> Aplastic polarizing lens including: a substrate layer including the molded body according to <3-9> or <3-10>; and a polarizing film.

<3-14> A method for producing a polymerizable composition for an optical material, the method including: a step (i) of producing an iso(thio)cyanate compound by reacting at least one amine compound (A) selected from the group consisting of an amine compound (a1) represented by the following general formula (1) and an amine compound (a2) represented by the following general formula (2) with an isocyanate compound (B) containing two or more iso(thio)cyanato groups; and a step (ii) of mixing an ultraviolet absorber (F) having a maximum absorption peak in a range of from 350 nm to 370 nm and including a compound represented by the following general formula (6), the iso(thio)cyanate compound, and a polythiol compound (C) including at least one selected from the group consisting of a dithiol compound (c1) containing two mercapto groups and a polythiol compound (c2) containing three or more mercapto groups to produce a composition.

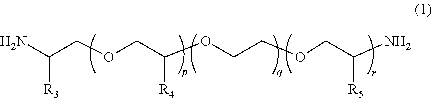

In general formula (1), each of R₃ to R₅ independently represents a hydrogen atom or a methyl group. p represents an integer from 0 to 100; q represents an integer from 0 to 100; r represents an integer from 0 to 100; and p+r equals an integer from 1 to 100. When a plurality of R₄ is present, respective R₄'s may be the same as or different from each other. When a plurality of R₅ is present, respective R₅'s may be the same as or different each other.

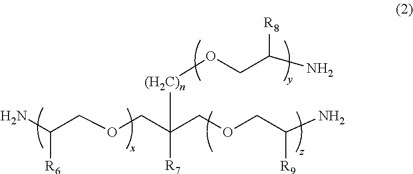

In general formula (2), each of R₆, R₈ and R₉ independently represents a hydrogen atom or a methyl group. R₇ represents a linear alkyl group having 1 to 20 carbon atoms, a branched alkyl group having 3 to 20 carbon atoms, or a cyclic alkyl group having 3 to 20 carbon atoms. x represents an integer from 0 to 200; y represents an integer from 0 to 200; z represents an integer from 0 to 200; and x+y+z equals an integer from 1 to 200. n represents an integer from 0 to 10. When a plurality of R₆ is present, respective R₆'s may be the same as or different from each other. When a plurality of R₈'s is present, respective R₈'s may be the same as or different from each other. When a plurality of R₉ is present, respective R₉'s may be the same as or different from each other.

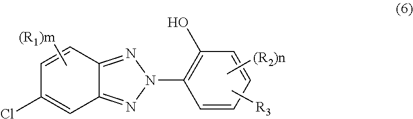

In general formula (6), each of R₁ and R₂ independently represents an alkyl group having 1 to 8 carbon atoms. When a plurality of R₁ is present, respective R₁'s may be the same as or different from each other. When a plurality of R₂ is present, respective R₂'s may be the same as or different from each other. R₃ represents a functional group having 2 to 15 carbon atoms and containing an ester bond. m represents an integer from 0 to 3; and n represents an integer from 0 to 3.

<3-15> A method for producing an optical material, the method including: a step of injecting the polymerizable composition for an optical material according to any one of <3-1> to <3-8> into a mold; and a step of polymerizing and curing the polymerizable composition for an optical material in the mold.

<3-16> A method for producing a plastic polarizing lens, the method including: a step of disposing a polarizing film in a mold; a step of injecting the polymerizable composition for an optical material according to any one of <3-1> to <3-8> into the mold in which the polarizing film is disposed; and a step of polymerizing and curing the polymerizable composition for an optical material to obtain a plastic polarizing lens including: a substrate layer including a molded body obtained by curing the polymerizable composition for an optical material; and a polarizing film.

### EXAMPLES

### Example A

Hereinafter, the first embodiment will be described in more detail with reference to examples, but is not limited to these examples.

In the present Example, the method for measuring a value of Mw/Mn is as described above.

As the GPC measuring device, Alliance and 2414 type differential refraction detector manufactured by Waters Corporation were used in Examples 1 to 9, Comparative Examples 1 and 2, Examples 101 to 104, and Examples 201 to 204.

LC-2030C LT PLUS and differential refractive index detector RID-20A manufactured by Shimadzu Corporation were used in Examples 10 to 11 and 105.

First, an evaluation method in the examples of the first embodiment will be described below.

<Evaluation Method>

(Haze)

Using a haze meter (NDH 2000 manufactured by NIPPON DENSHOKU INDUSTRIES CO., LTD.), the haze value of a flat molded body (thickness: 2.5 mm) obtained in each of Examples and Comparative Examples was measured.

When the haze value is less than 0.5, the molded body can be used as a lens without any problem.

(Impact Resistance Test 1)

First, a four-curve lens having a thickness of 2.5 mm and a diameter of 81 mm was prepared.

An iron-based projectile (mass: 500 g, diameter: 25.4 mm) with a conical tip was then dropped from a height of 127 cm through a loose guide tube to hit the lens.

A case where the sample after the test was not broken into two or more test pieces was evaluated as “A”, and a case where the sample after the test was broken into two or more test pieces was evaluated as “B”.

(Impact Resistance Test 2 (Puncture Test))

First, a four-curve lens having a thickness of 2.5 mm and a diameter of 81 mm was prepared.

Next, a puncture test was performed using a high-speed impact tester (Shimadzu HYDRO SHOT HITS-P-10 manufactured by Shimadzu Corporation) under the following conditions.

The puncture point was located near an intersection of the X axis.
Striker diameter: ½ inch Φ
Support base diameter: upper hole: 2.5 inch Φ, lower hole: 40 mmΦ
Test speed: 15 m/s
Test temperature: 23° C.
Fracture type: B brittle fracture
D ductile fracture

A case where the displacement at the maximum impact force point in the puncture test was 15.0 mm or more was evaluated as “A”, a case where the displacement was 10.0 mm or more and less than 15.0 mm was evaluated as “B”, and a case where the displacement was less than 10.0 mm was evaluated as “C”.

(Viscosity)

80 g of the measurement solution was weighed in a 110 mL screw tube having a diameter of 40 mm and a height of 125 mm, adjusted to 25° C., and then measured using a B-type viscometer manufactured by Brookfield.

### Example 1

(Preparation of iso(thio)cyanate Compound)

A reactor with D/d=1.9 was charged with 4027.5 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 250 rpm.

Under stirring at 250 rpm, 1743.6 parts by mass of poly(propylene glycol)bis(2-aminopropyl ether) (Jeffamine D-2000 manufactured by HUNTSMAN) [amine compound (A), compound (a1) represented by general formula (1)] having a weight average molecular weight of 2000 was added dropwise and charged at a dropping rate of 4.8 parts by mass/min, and reacted at 25° C. for 24 hours to obtain a solution containing an iso(thio)cyanate compound. The obtained iso(thio)cyanate compound-containing solution had a viscosity of 146 mPa·s.

The value of Mw/Mn of the obtained iso(thio)cyanate compound is shown in Table 1.

A mixture (3418.6 parts by mass) of 2,5-bis(isocyanatomethyl)bicyclo[2.2.1]heptane and 2,6-bis(isocyanatomethyl)bicyclo[2.2.1]heptane was added to, mixed with, and dissolved in 5316.9 parts by mass of the above solution to obtain a uniform solution.

Thereafter, a solution in which 10.96 parts by mass of dibutyltin dichloride and 43.86 parts by mass of an internal mold release agent (manufactured by Johoku Chemical Co., Ltd.; trade name: JP-506H) were uniformly dissolved was added to 292.3 parts by mass of a mixture of 2,5-bis(isocyanatomethyl)bicyclo[2.2.1]heptane and 2,6-bis(isocyanatomethyl)bicyclo[2.2.1]heptane, and they were mixed for dissolution to obtain a uniform solution.

Next, 3776.4 parts by mass of bis(2-mercaptoethyl)sulfide [dithiol compound (c1)] and 1820.4 parts by mass of 4-mercaptomethyl-1,8-dimercapto-3,6-dithiaoctane[polythiol compound (c2)] were added to, mixed with, and dissolved in the solution to obtain a uniform solution.

The uniform solution was defoamed at 400 Pa and then injected into a molding mold through a 1 m filter. This was put into a polymerization oven, and the temperature was gradually raised from 25° C. to 120° C. over 42 hours to perform polymerization and curing. After completion of the polymerization, the cured product was taken out from the oven, released from the molding mold, and further subjected to an annealing treatment at 120° C. for 1 hour to obtain a molded body.

The haze value of the obtained molded body is shown in Table 1.

### Example 2

(Preparation of iso(thio)cyanate Compound)

A reactor with D/d=3.1 was charged with 2998.8 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 325 rpm.

Under stirring at 325 rpm, 1298.3 parts by mass of poly(propylene glycol)bis(2-aminopropyl ether) (Jeffamine D-2000 manufactured by HUNTSMAN) [amine compound (A)] having a weight average molecular weight of 2000 was added dropwise and charged at a dropping rate of 4.8 parts by mass/min, and reacted at 25° C. for 24 hours to obtain a solution containing an iso(thio)cyanate compound. The obtained iso(thio)cyanate compound-containing solution had a viscosity of 168 mPa·s.

The value of Mw/Mn of the obtained iso(thio)cyanate compound is shown in Table 1.

A mixture (2159.8 parts by mass) of 2,5-bis(isocyanatomethyl)bicyclo[2.2.1]heptane and 2,6-bis(isocyanatomethyl)bicyclo[2.2.1]heptane was added to, mixed with, and dissolved in 3359.1 parts by mass of the above solution to obtain a uniform solution.

Thereafter, a solution in which 6.93 parts by mass of dibutyltin dichloride and 27.72 parts by mass of an internal mold release agent (manufactured by Johoku Chemical Co., Ltd.; trade name: JP-506H) were uniformly dissolved was added to 184.7 parts by mass of a mixture of 2,5-bis(isocyanatomethyl)bicyclo[2.2.1]heptane and 2,6-bis(isocyanatomethyl)bicyclo[2.2.1]heptane, and they were mixed for dissolution to obtain a uniform solution.

Next, 2384.4 parts by mass of bis(2-mercaptoethyl)sulfide [dithiol compound (c1)] and 1149.1 parts by mass of 4-mercaptomethyl-1,8-dimercapto-3,6-dithiaoctane[polythiol compound (c2)] were added to, mixed with, and dissolved in the solution to obtain a uniform solution.

A molded body was obtained in the same manner as in Example 1 except that the uniform solution described above was used.

The haze value of the obtained molded body is shown in Table 1.

### Example 3

(Preparation of iso(thio)cyanate Compound)

A reactor with D/d=1.7 was charged with 348.9 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 350 rpm.

Under stirring at 350 rpm, 151.1 parts by mass of poly(propylene glycol)bis(2-aminopropyl ether) (Jeffamine D-2000 manufactured by HUNTSMAN) [amine compound (A)] having a weight average molecular weight of 2000 was added dropwise and charged at a dropping rate of 2.5 parts by mass/min, and reacted at 25° C. for 24 hours to obtain a solution containing an iso(thio)cyanate compound. The obtained iso(thio)cyanate compound-containing solution had a viscosity of 152 mPa·s.

The value of Mw/Mn of the obtained iso(thio)cyanate compound is shown in Table 1.

Dibutyltin dichloride (0.075 parts by mass) and 0.30 parts by mass of an internal mold release agent (manufactured by Johoku Chemical Co., Ltd.; trade name: JP-506H) were mixed with and dissolved in 25.4 parts by mass of a mixture of 2,5-bis(isocyanatomethyl)bicyclo[2.2.1]heptane and 2,6-bis(isocyanatomethyl)bicyclo[2.2.1]heptane, and 36.4 parts by mass of the above solution was further added, and they were mixed for dissolution to obtain a uniform solution.

Next, 25.8 parts by mass of bis(2-mercaptoethyl)sulfide [dithiol compound (c1)] and 12.4 parts by mass of 4-mercaptomethyl-1,8-dimercapto-3,6-dithiaoctane[polythiol compound (c2)] were added to, mixed with, and dissolved in the solution to obtain a uniform solution.

The uniform solution was defoamed at 400 Pa and then injected into a molding mold through a 1 m filter. This was put into a polymerization oven, and the temperature was gradually raised from 25° C. to 120° C. over 24 hours to perform polymerization and curing. After completion of the polymerization, the cured product was taken out from the oven, released from the molding mold, and further subjected to an annealing treatment at 120° C. for 1 hour to obtain a molded body.

The haze value of the obtained molded body is shown in Table 1.

### Example 4

(Preparation of iso(thio)cyanate Compound)

A reactor with D/d=1.7 was charged with 348.9 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 250 rpm.

Under stirring at 250 rpm, 151.1 parts by mass of poly(propylene glycol)bis(2-aminopropyl ether) (Jeffamine D-2000 manufactured by HUNTSMAN) [amine compound (A)] having a weight average molecular weight of 2000 was added dropwise and charged at a dropping rate of 2.5 parts by mass/min, and reacted at 25° C. for 24 hours to obtain a solution containing an iso(thio)cyanate compound. The obtained iso(thio)cyanate compound-containing solution had a viscosity of 152 mPa·s.

The value of Mw/Mn of the obtained iso(thio)cyanate compound is shown in Table 1.

A molded body was obtained in the same manner as in Example 3 except that the uniform solution described above was used.

The haze value of the obtained molded body is shown in Table 1.

### Example 5

(Preparation of iso(thio)cyanate Compound)

A reactor with D/d=1.7 was charged with 348.9 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 200 rpm. Under stirring at 200 rpm, 151.1 parts by mass of poly(propylene glycol)bis(2-aminopropyl ether) (Jeffamine D-2000 manufactured by HUNTSMAN) [amine compound (A)] having a weight average molecular weight of 2000 was added dropwise and charged at a dropping rate of 2.5 parts by mass/min, and reacted at 25° C. for 24 hours to obtain a solution containing an iso(thio)cyanate compound. The obtained iso(thio)cyanate compound-containing solution had a viscosity of 176 mPa·s.

The value of Mw/Mn of the obtained iso(thio)cyanate compound is shown in Table 1.

A molded body was obtained in the same manner as in Example 3 except that the uniform solution described above was used.

The haze value of the obtained molded body is shown in Table 1.

### Example 6

(Preparation of iso(thio)cyanate Compound)

A reactor with D/d=1.7 was charged with 348.9 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 150 rpm.

Under stirring at 150 rpm, 151.1 parts by mass of poly(propylene glycol)bis(2-aminopropyl ether) (Jeffamine D-2000 manufactured by HUNTSMAN) [amine compound (A)] having a weight average molecular weight of 2000 was added dropwise and charged at a dropping rate of 2.5 parts by mass/min, and reacted at 25° C. for 24 hours to obtain a solution containing an iso(thio)cyanate compound. The obtained iso(thio)cyanate compound-containing solution had a viscosity of 214 mPa·s.

The value of Mw/Mn of the obtained iso(thio)cyanate compound is shown in Table 1.

A molded body was obtained in the same manner as in Example 3 except that the uniform solution described above was used.

The haze value of the obtained molded body is shown in Table 1.

### Example 7

(Preparation of iso(thio)cyanate Compound)

A reactor with D/d=1.7 was charged with 348.9 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 150 rpm.

Under stirring at 150 rpm, 151.1 parts by mass of poly(propylene glycol)bis(2-aminopropyl ether) (Jeffamine D-2000 manufactured by HUNTSMAN) [amine compound (A)] having a weight average molecular weight of 2000 was added dropwise and charged at a dropping rate of 4.6 parts by mass/min, and reacted at 25° C. for 24 hours to obtain a solution containing an iso(thio)cyanate compound. The obtained iso(thio)cyanate compound-containing solution had a viscosity of 218 ps.

The value of Mw/Mn of the obtained iso(thio)cyanate compound is shown in Table 1.

A molded body was obtained in the same manner as in Example 3 except that the uniform solution described above was used.

The haze value of the obtained molded body is shown in Table 1.

### Example 8

(Preparation of iso(thio)cyanate Compound)

A reactor with D/d=1.7 was charged with 348.9 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 350 rpm.

Under stirring at 350 rpm, 151.1 parts by mass of poly(propylene glycol)bis(2-aminopropyl ether) (Jeffamine D-2000 manufactured by HUNTSMAN) [amine compound (A)] having a weight average molecular weight of 2000 was charged at a rate of 100 parts by mass/min, and reacted at 25° C. for 24 hours to obtain a solution containing an iso(thio)cyanate compound. The obtained iso(thio)cyanate compound-containing solution had a viscosity of 158 mPa·s.

The value of Mw/Mn of the obtained iso(thio)cyanate compound is shown in Table 1.

A molded body was obtained in the same manner as in Example 3 except that the uniform solution described above was used.

The haze value of the obtained molded body is shown in Table 1.

### Example 9

(Preparation of iso(thio)cyanate Compound)

A reactor with D/d=3.1 was charged with 3114.9 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 250 rpm.

Under stirring at 250 rpm, 1348.5 parts by mass of poly(propylene glycol)bis(2-aminopropyl ether) (Jeffamine D-2000 manufactured by HUNTSMAN) [amine compound (A)] having a weight average molecular weight of 2000 was added dropwise and charged at a dropping rate of 4.5 parts by mass/min, and reacted at 25° C. for 24 hours to obtain a solution containing an iso(thio)cyanate compound. The obtained iso(thio)cyanate compound-containing solution had a viscosity of 202 mPa·s.

The value of Mw/Mn of the obtained iso(thio)cyanate compound is shown in Table 1.

A mixture (2215.2 parts by mass) of 2,5-bis(isocyanatomethyl)bicyclo[2.2.1]heptane and 2,6-bis(isocyanatomethyl)bicyclo[2.2.1]heptane was added to, mixed with, and dissolved in 3445.8 parts by mass of the above solution to obtain a uniform solution.

Thereafter, a solution in which 7.10 parts by mass of dibutyltin dichloride and 28.42 parts by mass of an internal mold release agent (manufactured by Johoku Chemical Co., Ltd.; trade name: JP-506H) were uniformly dissolved was added to 189.5 parts by mass of a mixture of 2,5-bis(isocyanatomethyl)bicyclo[2.2.1]heptane and 2,6-bis(isocyanatomethyl)bicyclo[2.2.1]heptane, and they were mixed for dissolution to obtain a uniform solution.

Next, 2445.4 parts by mass of bis(2-mercaptoethyl)sulfide [dithiol compound (c1)] and 1178.6 parts by mass of 4-mercaptomethyl-1,8-dimercapto-3,6-dithiaoctane[polythiol compound (c2)] were added to, mixed with, and dissolved in the solution to obtain a uniform solution.

A molded body was obtained in the same manner as in Example 1 except that the uniform solution described above was used.

The haze value of the obtained molded body is shown in Table 1.

### Comparative Example 1

(Preparation of iso(thio)cyanate Compound)

A reactor with D/d=3.1 was charged with 3006.7 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 150 rpm.

Under stirring at 150 rpm, 1301.7 parts by mass of poly(propylene glycol)bis(2-aminopropyl ether) (Jeffamine D-2000 manufactured by HUNTSMAN) [amine compound (A)] having a weight average molecular weight of 2000 was added dropwise and charged at a dropping rate of 4.9 parts by mass/min, and reacted at 25° C. for 24 hours to obtain a solution containing an iso(thio)cyanate compound. The obtained iso(thio)cyanate compound-containing solution had a viscosity of 256 mPa·s.

The value of Mw/Mn of the obtained iso(thio)cyanate compound is shown in Table 1.

A mixture (2469.8 parts by mass) of 2,5-bis(isocyanatomethyl)bicyclo[2.2.1]heptane and 2,6-bis(isocyanatomethyl)bicyclo[2.2.1]heptane was added to, mixed with, and dissolved in 3840.5 parts by mass of the above solution to obtain a uniform solution.

Thereafter, a solution in which 7.92 parts by mass of dibutyltin dichloride and 31.67 parts by mass of an internal mold release agent (manufactured by Johoku Chemical Co., Ltd.; trade name: JP-506H) were uniformly dissolved was added to, mixed with and dissolved in 211.2 parts by mass of a mixture of 2,5-bis(isocyanatomethyl)bicyclo[2.2.1]heptane and 2,6-bis(isocyanatomethyl)bicyclo[2.2.1]heptane to obtain a uniform solution.

Next, 2726.1 parts by mass of bis(2-mercaptoethyl)sulfide [dithiol compound (c1)] and 1312.7 parts by mass of 4-mercaptomethyl-1,8-dimercapto-3,6-dithiaoctane[polythiol compound (c2)] were added to, mixed with, and dissolved in the solution to obtain a uniform solution.

A molded body was obtained in the same manner as in Example 1 except that the uniform solution described above was used.

The haze value and impact durability of the obtained molded body are shown in Table 1.

### Comparative Example 2

(Preparation of iso(thio)cyanate Compound)

A reactor with D/d=1.7 was charged with 348.9 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 120 rpm.

Under stirring at 120 rpm, 151.1 parts by mass of poly(propylene glycol)bis(2-aminopropyl ether) (Jeffamine D-2000 manufactured by HUNTSMAN) [amine compound (A)] having a weight average molecular weight of 2000 was added dropwise and charged at a dropping rate of 2.5 parts by mass/min, and reacted at 25° C. for 24 hours to obtain a solution containing an iso(thio)cyanate compound. The obtained iso(thio)cyanate compound-containing solution had a viscosity of 234 mPa·s.

The value of Mw/Mn of the obtained iso(thio)cyanate compound is shown in Table 1.

Dibutyltin dichloride (0.075 parts by mass) and 0.30 parts by mass of an internal mold release agent (manufactured by Johoku Chemical Co., Ltd.; trade name: JP-506H) were mixed with and dissolved in 25.4 parts by mass of a mixture of 2,5-bis(isocyanatomethyl)bicyclo[2.2.1]heptane and 2,6-bis(isocyanatomethyl)bicyclo[2.2.1]heptane, 36.4 parts by mass of the above solution was further added, and they were mixed for dissolution to obtain a uniform solution.

Next, 25.8 parts by mass of bis(2-mercaptoethyl)sulfide [dithiol compound (c1)] and 12.4 parts by mass of 4-mercaptomethyl-1,8-dimercapto-3,6-dithiaoctane[polythiol compound (c2)] were added to, mixed with, and dissolved in the solution to obtain a uniform solution.

A molded body was obtained in the same manner as in Example 3 except that the uniform solution described above was used.

The haze value of the obtained molded body is shown in Table 1.

TABLE 1

| | | Example | Example | Example | Example | Example | Example | Example | Example | Example | Comparative | Comparative |
|---|---|---|---|---|---|---|---|---|---|---|---|---|
| | | 1 | 2 | 3 | 4 | 5 | 6 | 7 | 8 | 9 | Example 1 | Example 2 |
| Iso(thio)cyanate | Mw/Mn | 1.13 | 1.19 | 1.17 | 1.17 | 1.20 | 1.25 | 1.25 | 1.14 | 1.31 | 1.33 | 1.35 |
| compound | | | | | | | | | | | | |
| Condition for | Stirring rate [rpm] | 250 | 325 | 350 | 250 | 200 | 150 | 150 | 350 | 250 | 150 | 120 |
| preparing | when mixing | | | | | | | | | | | |
| iso(thio)cyanate | amine compound | | | | | | | | | | | |
| compound | (A) and | | | | | | | | | | | |
| | iso(thio)cyanate | | | | | | | | | | | |
| | compound (B) | | | | | | | | | | | |
| | D/d | 1.9 | 3.1 | 1.7 | 1.7 | 1.7 | 1.7 | 1.7 | 1.7 | 3.1 | 3.1 | 1.7 |
| Haze | | 0.12 | 0.15 | 0.16 | 0.19 | 0.22 | 0.44 | 0.47 | 0.15 | 0.37 | 98.81 | 95.00 |
| Impact | Evaluation | A | A | A | A | — | — | — | — | A | A | — |
| resistance test 1 | | | | | | | | | | | | |
| Impact | Displacement at | 15.24 | 15.72 | — | — | — | — | — | — | 15.73 | 16.01 | — |
| resistance test 2 | maximum impact | | | | | | | | | | | |
| | force point [mm] | | | | | | | | | | | |
| | Evaluation | A | A | — | — | — | — | — | — | A | A | — |

As shown in Table 1, the haze was less than 0.5, and turbidity was well suppressed, in the Examples each using the iso(thio)cyanate compound that is the reaction product between the amine compound (A) including at least one selected from the compound (a1) represented by general formula (1) and the compound (a2) represented by general formula (2) and the bi- or higher-functional iso(thio)cyanate compound (B), the iso(thio)cyanate compound having a value of Mw/Mn of 1.31 or less, the value of Mw/Mn being a weight average molecular weight (Mw) divided by a number average molecular weight (Mn).

On the other hand, in Comparative Examples 1 and 2 each using the iso(thio)cyanate compound having a value of Mw/Mn of more than 1.31, the haze value was high, and turbidity could not be suppressed.

### Example 10

(Preparation of iso(thio)cyanate Compound)

A reactor with D/d=1.9 was charged with 4009.9 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 250 rpm.

Under stirring at 250 rpm, 1736.4 parts by mass of poly(propylene glycol)bis(2-aminopropyl ether) (Jeffamine D-2000 manufactured by HUNTSMAN) [amine compound (A), compound (a1) represented by general formula (1)] having a weight average molecular weight of 2000 was added dropwise and charged at a dropping rate of 4.8 parts by mass/min, and reacted at 25° C. for 24 hours to obtain a solution containing a first iso(thio)cyanate compound.

The obtained solution containing the first iso(thio)cyanate compound had a viscosity of 145 mPa·s.

The value of Mw/Mn of the obtained first iso(thio)cyanate compound was 1.11.

Subsequently, 851.5 parts by mass of the first iso(thio)cyanate compound obtained above and 103.6 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane were put into a reactor with D/d=1.3, and they were stirred under the conditions of 25° C. and 350 rpm to obtain a uniform solution. Thereafter, under stirring at 350 rpm, 44.9 parts by mass of poly(propylene glycol)bis(2-aminopropyl ether) (Jeffamine D-4000 manufactured by HUNTSMAN) [amine compound (A), compound (a1) represented by general formula (1)] having a weight average molecular weight of 4000 was charged, and reacted at 25° C. for 24 hours to obtain a solution containing a second iso(thio)cyanate compound (corresponding to the iso(thio)cyanate compound of the first embodiment).

The obtained solution containing the second iso(thio)cyanate compound had a viscosity of 141 mPa·s.

The value of Mw/Mn of the obtained second iso(thio)cyanate compound is shown in Table 2.

A mixture (57.96 parts by mass) of 2,5-bis(isocyanatomethyl)bicyclo[2.2.1]heptane and 2,6-bis(isocyanatomethyl)bicyclo[2.2.1]heptane was added to 0.15 parts by mass of dibutyltin dichloride and 0.90 parts by mass of an internal mold release agent (manufactured by Johoku Chemical Co., Ltd.; trade name: JP-506H), and they were mixed for dissolution to obtain a uniform solution.

Further, 128.28 parts by mass of the solution containing the second iso(thio)cyanate compound obtained above was added to the solution, and they were mixed for dissolution to obtain a uniform solution.

Next, 53.52 parts by mass of bis(2-mercaptoethyl)sulfide [dithiol compound (c1)] and 60.24 parts by mass of 4-mercaptomethyl-1,8-dimercapto-3,6-dithiaoctane[polythiol compound (c2)] were added to, mixed with, and dissolved in the solution to obtain a uniform solution.

The uniform solution was filtered through a 1 m filter, defoamed at 400 Pa, and then injected into a molding mold. This was put into a polymerization oven, and the temperature was gradually raised from 20° C. to 120° C. over 42 hours to perform polymerization and curing. After completion of the polymerization, the cured product was taken out from the oven, released from the molding mold, and further subjected to an annealing treatment at 120° C. for 1 hour to obtain a molded body.

The haze value of the obtained molded body is shown in Table 2.

### Example 11

(Preparation of iso(thio)cyanate Compound)

A reactor with D/d=1.9 was charged with 4009.9 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 250 rpm.

Under stirring at 250 rpm, 1736.4 parts by mass of poly(propylene glycol)bis(2-aminopropyl ether) (Jeffamine D-2000 manufactured by HUNTSMAN) [amine compound (A), compound (a1) represented by general formula (1)] having a weight average molecular weight of 2000 was added dropwise and charged at a dropping rate of 4.8 parts by mass/min, and reacted at 25° C. for 24 hours to obtain a solution containing an iso(thio)cyanate compound.

The obtained iso(thio)cyanate compound-containing solution had a viscosity of 145 mPa·s.

The value of Mw/Mn of the obtained iso(thio)cyanate compound is shown in Table 2.

A mixture (170.62 parts by mass) of 2,5-bis(isocyanatomethyl)bicyclo[2.2.1]heptane and 2,6-bis(isocyanatomethyl)bicyclo[2.2.1]heptane was added to 0.30 parts by mass of dibutyltin dichloride and 1.20 parts by mass of an internal mold release agent (manufactured by Johoku Chemical Co., Ltd.; trade name: JP-506H), and they were mixed for dissolution to obtain a uniform solution.

Further, 66.18 parts by mass of the iso(thio)cyanate compound-containing solution obtained above was added to the solution, and they were mixed for dissolution to obtain a uniform solution.

Next, 110.20 parts by mass of bis(2-mercaptoethyl)sulfide [dithiol compound (c1)] and 53.08 parts by mass of 4-mercaptomethyl-1,8-dimercapto-3,6-dithiaoctane[polythiol compound (c2)] were added to, mixed with, and dissolved in the solution to obtain a uniform solution.

The uniform solution was filtered through a 1 m filter, defoamed at 400 Pa, and then injected into a molding mold. This was put into a polymerization oven, and the temperature was gradually raised from 20° C. to 120° C. over 42 hours to perform polymerization and curing. After completion of the polymerization, the cured product was taken out from the oven, released from the molding mold, and further subjected to an annealing treatment at 120° C. for 1 hour to obtain a molded body.

The haze value of the obtained molded body is shown in Table 2.

TABLE 2

| | | Example 10 | Example 11 |
|---|---|---|---|
| Iso(thio)cyanate | Mw/Mn | 1.17 | 1.11 |
| compound | | | |
| Condition for | Stirring rate [rpm] | 350 | 250 |
| preparing | when mixing amine | | |
| iso(thio)cyanate | compound (A) and | | |
| compound | iso(thio)cyanate | | |
| | compound (B) | | |
| | D/d | 1.3 | 1.9 |
| Haze | | 0.25 | 0.09 |
| Impact | Evaluation | A | A |
| resistance | | | |
| test 1 | | | |

As shown in Table 2, the haze was less than 0.5, and turbidity was well suppressed, in the Examples each using the iso(thio)cyanate compound that is the reaction product between the amine compound (A) including at least one selected from the compound (a1) represented by general formula (1) and the compound (a2) represented by general formula (2) and the bi- or higher-functional iso(thio)cyanate compound (B), the iso(thio)cyanate compound having a value of Mw/Mn of 1.31 or less, the value of Mw/Mn being a weight average molecular weight (Mw) divided by a number average molecular weight (Mn). In addition, because of excellent results of the impact resistance test, the strength was excellent.

### Example B

Hereinafter, the second embodiment will be described in more detail with reference to examples, but is not limited to these examples.

In the present Example, the method for measuring a value of Mw/Mn is as described above.

First, an evaluation method in the examples of the second embodiment will be described below.

<Evaluation Method>

(Haze)

Using a haze meter (NDH 2000 manufactured by NIPPON DENSHOKU INDUSTRIES CO., LTD.), the haze value of a flat molded body (thickness: 2.5 mm) obtained in each of Examples and Comparative Examples was measured.

When the haze value is less than 0.5, the molded body can be used as a lens without any problem.

(Impact Resistance Test)

First, a four-curve lens having a thickness of 2.5 mm and a diameter of 81 mm was prepared.

An iron projectile (mass: 500 g, diameter: 25.4 mm) with a conical tip was then dropped from a height of 127 cm through a guide tube having an inner diameter of 30.0 mm to hit the lens.

—Evaluation—

A case where the sample after the test was not broken into two or more test pieces was evaluated as “A”, and a case where the sample after the test was broken into two or more test pieces was evaluated as “B”.

(Viscosity)

80 g of the measurement solution was weighed in a 110 mL screw tube having a diameter of 40 mm and a height of 125 mm, adjusted to 25° C., and then measured using a B-type viscometer manufactured by Brookfield.

(Heat Resistance)
Device: TMA-60 manufactured by SHIMADZU Corporation
Technique: TMA penetration method (50 g load, pin tip: 0.5 mm, temperature raising rate: 10° C./min)

The glass transition temperature Tg was measured using the device and technique.

(Stria)

A 4C lens having a center thickness of 10.5 mm was prepared, and a lens image projected on a white plate by applying a high-pressure mercury lamp from a concave surface of the lens was visually confirmed.

—Evaluation—

A case where no streaky line was observed was evaluated as “A”, a case where some streaky lines were observed but the lens was acceptable as a product was evaluated as “B”, and a case where many streaky lines were observed and the lens was unacceptable as a product was evaluated as “C”.

### Example 101

(Preparation of iso(thio)cyanate Compound)

A reactor with D/d=1.9 was charged with 4076.4 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 250 rpm.

Under stirring at 250 rpm, 1764.8 parts by mass of poly(propylene glycol)bis(2-aminopropyl ether) (Jeffamine D-2000 manufactured by HUNTSMAN) [amine compound (A), compound (a1) represented by general formula (1)] having a weight average molecular weight of 2000 was added dropwise and charged at a dropping rate of 5.1 parts by mass/min, and reacted at 25° C. for 24 hours to obtain a solution containing an iso(thio)cyanate compound.

The obtained iso(thio)cyanate compound-containing solution had a viscosity of 149 mPa·s.

The value of Mw/Mn of the obtained iso(thio)cyanate compound was 1.12.

To 457.7 parts by mass of a mixture of 2,5-bis(isocyanatomethyl)bicyclo[2.2.1]heptane and 2,6-bis(isocyanatomethyl)bicyclo[2.2.1]heptane, 727.5 parts by mass of the solution containing the iso(thio)cyanate compound obtained above was added, and they were mixed for dissolution to obtain a uniform solution.

Then, a solution in which 0.60 parts by mass of dibutyltin dichloride and 6.0 parts by mass of an internal mold release agent (manufactured by Johoku Chemical Co., Ltd.; trade name: JP-506H) were uniformly dissolved was added to 40.0 parts by mass of a mixture of 2,5-bis(isocyanatomethyl)bicyclo[2.2.1]heptane and 2,6-bis(isocyanatomethyl)bicyclo[2.2.1]heptane, and they were mixed for dissolution to obtain a uniform solution.

Further, to 10.0 parts by mass of a mixture of 2,5-bis(isocyanatomethyl)bicyclo[2.2.1]heptane and 2,6-bis(isocyanatomethyl)bicyclo[2.2.1]heptane, a solution in which 0.50 parts by mass of 3,5-lutidine was uniformly dissolved was added, and they were mixed for dissolution to obtain a uniform solution.

Next, 516.2 parts by mass of bis(2-mercaptoethyl)sulfide [dithiol compound (c1)] and 248.6 parts by mass of 4-mercaptomethyl-1,8-dimercapto-3,6-dithiaoctane[polythiol compound (c2)] were added to, mixed with, and dissolved in the solution to obtain a uniform solution.

The uniform solution was defoamed at 400 Pa and then injected into a molding mold through a 1 m filter. This was charged into a polymerization oven with the lens convex surface facing upward, and the temperature was gradually raised from 15° C. to 30° C. over 20 hours, from 30° C. to 35° C. over 12 hours, from 35° C. to 45° C. over 6 hours, from 45° C. to 65° C. over 3 hours, from 65° C. to 95° C. over 3 hours, and from 95° C. to 120° C. over 1 hour, and held at 120° C. for 2 hours for curing.

After completion of the polymerization, cooling was performed to room temperature, and the cured product was then taken out from the oven, released from the molding mold, and further subjected to an annealing treatment at 120° C. for 1 hour to obtain a molded body.

The physical property values of the obtained molded body are shown in Table 3.

### Example 102

A molded body was obtained in the same manner as in Example 101 except that the content of dibutyltin dichloride was changed to 0.40 parts by mass.

The physical property values of the obtained molded body are shown in Table 3.

### Example 103

A molded body was obtained in the same manner as in Example 102 except that, after the molding mold containing the uniform solution was charged into the polymerization oven, and the temperature was gradually raised from 20° C. to 30° C. over 2 hours, from 30° C. to 40° C. over 15 hours, from 40° C. to 50° C. over 8 hours, from 50° C. to 65° C. over 8 hours, from 65° C. to 95° C. over 6 hours, and from 95° C. to 120° C. over 1 hour, and held at 120° C. for 2 hours for curing.

The physical property values of the obtained molded body are shown in Table 3.

### Example 104

A mixture (106.62 parts by mass) of 2,5-bis(isocyanatomethyl)bicyclo[2.2.1]heptane and 2,6-bis(isocyanatomethyl)bicyclo[2.2.1]heptane was added to 0.168 parts by mass of dibutyltin dichloride, 0.105 parts by mass of 3,5-lutidine, and 1.26 parts by mass of an internal mold release agent (manufactured by Johoku Chemical Co., Ltd.; trade name: JP-506H), and they were mixed for dissolution to obtain a uniform solution.

Further, 152.77 parts by mass of the iso(thio)cyanate compound-containing solution described in Example 101 was added to the solution, and they were mixed for dissolution to obtain a uniform solution.

Next, 108.40 parts by mass of bis(2-mercaptoethyl)sulfide [dithiol compound (c1)] and 52.21 parts by mass of 4-mercaptomethyl-1,8-dimercapto-3,6-dithiaoctane[polythiol compound (c2)] were added to, mixed with, and dissolved in the solution to obtain a uniform solution.

The uniform solution was defoamed at 400 Pa and then injected into a molding mold through a 1 m filter. This was charged into a polymerization oven with the lens convex surface facing upward, and the temperature was gradually raised from 15° C. to 30° C. over 20 hours, from 30° C. to 35° C. over 12 hours, from 35° C. to 45° C. over 6 hours, from 45° C. to 65° C. over 3 hours, from 65° C. to 95° C. over 3 hours, and from 95° C. to 120° C. over 1 hour, and held at 120° C. for 2 hours for curing.

After completion of the polymerization, cooling was performed to room temperature, and the cured product was then taken out from the oven, released from the molding mold, and further subjected to an annealing treatment at 120° C. for 1 hour to obtain a molded body.

The physical property values of the obtained molded body are shown in Table 3.

TABLE 3

| | | Example | Example | Example | Example |
|---|---|---|---|---|---|
| | | 101 | 102 | 103 | 104 |
| Organotin compound (D) | DBC [ppm] | 300 | 200 | 200 | 400 |
| Tertiary amine compound (E) | 3,5-Lutidine [ppm] | 250 | 250 | 250 | 250 |

| | | | | |
|---|---|---|---|---|
| Heat resistance (Tg) [° C.] | 87.4 | 85.9 | 85.9 | 87.4 |
| Haze | 0.2 | — | 0.16 | — |
| Striae (4 C, 10.5 mm) | A | A | B | A |
| Impact resistance test | A | — | A | — |

As shown in Table 3, a cure product having suppressed striae could be obtained, in the Examples each using the polymerizable composition for an optical material containing the amine compound (A) including at least one selected from the group consisting of the compound (a1) represented by general formula (1) and the compound (a2) represented by general formula (2), the bi- or higher-functional iso(thio)cyanate compound (B), the polythiol compound (C) including at least one selected from the group consisting of the dithiol compound (c1) containing two mercapto groups and the polythiol compound (c2) containing three or more mercapto groups, the organotin compound (D), and the tertiary amine compound (E).

The Examples employed the iso(thio)cyanate compound that is a reaction product between the amine compound (A) including at least one selected from the compound (a1) represented by general formula (1) or the compound (a2) represented by general formula (2) and the bi- or higher-functional iso(thio)cyanate compound (B), the iso(thio)cyanate compound having a value of Mw/Mn of 1.12, the value of Mw/Mn being the weight average molecular weight (Mw) divided by the number average molecular weight (Mn).

On the other hand, in the Comparative Examples using the polymerizable composition for an optical material containing no tertiary amine compound (E), a cured product with suppressed striae could not be obtained.

### Example 105

(Preparation of iso(thio)cyanate Compound)

A reactor with D/d=1.7 was charged with 348.9 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 25° C. and 200 rpm. Under stirring at 200 rpm, 151.1 parts by mass of poly(propylene glycol)bis(2-aminopropyl ether) (Jeffamine D-2000 manufactured by HUNTSMAN) [amine compound (A)] having a weight average molecular weight of 2000 was added dropwise and charged at a dropping rate of 2.5 parts by mass/min, and reacted at 25° C. for 24 hours to obtain a solution containing an iso(thio)cyanate compound. The obtained iso(thio)cyanate compound-containing solution had a viscosity of 166 mPa·s.

The value of Mw/Mn of the obtained iso(thio)cyanate compound is shown in Table 4.

A mixture (63.46 parts by mass) of 2,5-bis(isocyanatomethyl)bicyclo[2.2.1]heptane and 2,6-bis(isocyanatomethyl)bicyclo[2.2.1]heptane was added to 0.10 parts by mass of dibutyltin dichloride, 0.10 parts by mass of 3,5-lutidine, and 1.25 parts by mass of an internal mold release agent (manufactured by Johoku Chemical Co., Ltd.; trade name: JP-506H), and they were mixed for dissolution to obtain a uniform solution.

Further, 90.94 parts by mass of the iso(thio)cyanate compound-containing solution obtained above was added to the solution, and they were mixed for dissolution to obtain a uniform solution.

Next, 64.52 parts by mass of bis(2-mercaptoethyl)sulfide [dithiol compound (c1)] and 31.08 parts by mass of 4-mercaptomethyl-1,8-dimercapto-3,6-dithiaoctane[polythiol compound (c2)] were added to, mixed with, and dissolved in the solution to obtain a uniform solution.

The uniform solution was filtered through a 1 m filter, defoamed at 400 Pa, and then injected into a molding mold. This was put into a polymerization oven, and the temperature was gradually raised from 15° C. to 120° C. over 56 hours to perform polymerization and curing. After completion of the polymerization, the cured product was taken out from the oven, released from the molding mold, and further subjected to an annealing treatment at 120° C. for 1 hour to obtain a molded body.

The haze value of the obtained molded body is shown in Table 4.

TABLE 4

| | | Example 105 |
|---|---|---|
| Iso(thio)cyanate | Mw/Mn | 1.23 |
| compound | | |
| Condition for | Stirring rate [rpm] when | 200 |
| preparing | mixing amine compound | |
| iso(thio)cyanate | (A) and iso(thio)cyanate | |
| compound | compound (B) | |
| | D/d | 1.73 |
| Haze | | 0.22 |
| Impact resistance test 1 | Evaluation | A |

As shown in Table 4, an excellent haze was obtained, in the Examples each using the polymerizable composition for an optical material containing the amine compound (A) including at least one selected from the group consisting of the compound (a1) represented by general formula (1) or the compound (a2) represented by general formula (2), the bi- or higher-functional iso(thio)cyanate compound (B), the polythiol compound (C) including at least one selected from the group consisting of the dithiol compound (c1) containing two mercapto groups and the polythiol compound (c2) containing three or more mercapto groups, the organotin compound (D), and the tertiary amine compound (E).

When a prepolymer (for example, the solution containing the iso(thio)cyanate compound in Example 105) containing a large amount of a high molecular weight component is cured with a 3,5-lutidine-based catalyst, the cured product tends to be cloudy. In such a case, as in Example 105, the cloudiness can be suppressed by using a relatively large amount of mold release agent.

### Example C

Hereinafter, the third embodiment will be described in more detail with reference to examples, but is not limited to these examples.

In the present Example, the method for measuring a value of Mw/Mn is as described above.

First, an evaluation method in the examples of the third embodiment will be described below.

<Evaluation Method>

(Haze)

Using a haze meter (NDH 2000 manufactured by NIPPON DENSHOKU INDUSTRIES CO., LTD.), the haze value of a molded body (thickness: 2.5 mm) obtained in each of Examples and Comparative Examples was measured.

When the haze value is less than 0.5, the molded body can be used as a lens without any problem.

(Impact Resistance Test)

First, a four-curve lens having a thickness of 2.5 mm and a diameter of 81 mm was prepared.

An iron projectile (mass: 500 g, diameter: 25.4 mm) with a conical tip was then dropped from a height of 127 cm through a guide tube having an inner diameter of 30.0 mm to hit the lens.

—Evaluation—

A case where the sample after the test was not broken into two or more test pieces was evaluated as “A”, and a case where the sample after the test was broken into two or more test pieces was evaluated as “B”.

(Viscosity)

80 g of the measurement solution was weighed in a 110 mL screw tube having a diameter of 40 mm and a height of 125 mm, adjusted to 25° C., and then measured using a B-type viscometer manufactured by Brookfield.

(Heat Resistance)
Device: TMA-60 manufactured by SHIMADZU Corporation
Technique: TMA penetration method (50 g load, pin tip: 0.5 mm, temperature raising rate: 10° C./min)

The glass transition temperature Tg was measured using the device and technique.

—Evaluation—

A case where the glass transition temperature Tg was 87° C. or higher was evaluated as “A”, and a case where the glass transition temperature Tg was lower than 87° C. was evaluated as “B”.

(400 nm Cut Rate)

A 2.5 mm flat plate was prepared, and the transmittance was measured using the following device and under the following conditions.

From the transmittance at 400 nm in the obtained transmittance data, a 400 nm cut rate was calculated. Details are as follows.

400 nm cut rate=100−(400 nm transmittance)
Device: UV-Vis spectrophotometer UV-1800 manufactured by Shimadzu Corporation
Wavelength range (nm): start: 800, end: 350
Scan speed: high speed
Sampling pitch (nm): 1.0
Type of measurement value: transmittance

—Evaluation—

A case where the cut rate was 90% or higher was evaluated as “A”, and a case where the cut rate was lower than 90% was evaluated as “B”.

Details of the ultraviolet absorber used in this example are as follows.
Eversorb 109 (manufactured by EVERLIGHT CHEMICAL, a mixture of octyl-3-[3-tert-butyl-4-hydroxy-5-(5-chloro-2H-benzotriazole-2-yl) phenyl]propionate and 2-ethylhexyl-3-[3-tert-butyl-4-hydroxy-5-(5-chloro-2H-benzotriazole-2-yl)phenyl]propionate)
Eversorb 109 has a maximum absorption peak in a range of from 350 nm to 370 nm, and has the following structure.

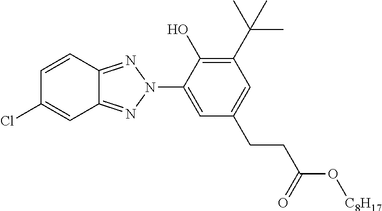

### Example 201

(Preparation of iso(thio)cyanate Compound)

A reactor with D/d=1.9 was charged with 4019.2 parts by mass of a mixture [iso(thio)cyanate compound (B)] of 2,5-bis(isocyanatomethyl)bicyclo[2.2.1]heptane and 2,6-bis(isocyanatomethyl)bicyclo[2.2.1]heptane, and the mixture was stirred at 26° C. and 250 rpm.

Under stirring at 250 rpm, 1740.0 parts by mass of poly(propylene glycol)bis(2-aminopropyl ether) (Jeffamine D-2000 manufactured by HUNTSMAN) [amine compound (A), compound (a1) represented by general formula (1)] having a weight average molecular weight of 2000 was added dropwise and charged at a dropping rate of 4.8 parts by mass/min, and reacted at 26° C. for 24 hours to obtain a solution containing an iso(thio)cyanate compound.

The obtained iso(thio)cyanate compound-containing solution had a viscosity of 179 mPa·s.

The value of Mw/Mn of the obtained iso(thio)cyanate compound was 1.14.

To 4.0 parts by mass of Eversorb 109 (manufactured by EVERLIGHT CHEMICAL, a mixture of octyl-3-[3-tert-butyl-4-hydroxy-5-(5-chloro-2H-benzotriazole-2-yl) phenyl]propionate and 2-ethylhexyl-3-[3-tert-butyl-4-hydroxy-5-(5-chloro-2H-benzotriazole-2-yl)phenyl]propionate), 457.7 parts by mass of a mixture of 2,5-bis(isocyanatomethyl)bicyclo[2.2.1]heptane and 2,6-bis(isocyanatomethyl)bicyclo[2.2.1]heptane was added, and they were mixed for dissolution.

Further, 727.5 parts by mass of the iso(thio)cyanate compound-containing solution obtained above was added to the solution, and they were mixed for dissolution to obtain a uniform solution.

Thereafter, a solution in which 0.60 parts by mass of dibutyltin dichloride and 6.0 parts by mass of an internal mold release agent (manufactured by Johoku Chemical Co., Ltd.; trade name: JP-506H) were uniformly dissolved was added to 40.0 parts by mass of a mixture of 2,5-bis(isocyanatomethyl)bicyclo[2.2.1]heptane and 2,6-bis(isocyanatomethyl)bicyclo[2.2.1]heptane, and they were mixed for dissolution to obtain a uniform solution.

Further, to 10.0 parts by mass of a mixture of 2,5-bis(isocyanatomethyl)bicyclo[2.2.1]heptane and 2,6-bis(isocyanatomethyl)bicyclo[2.2.1]heptane, a solution in which 0.50 parts by mass of 3,5-lutidine was uniformly dissolved was added, and they were mixed for dissolution to obtain a uniform solution.

Next, 516.2 parts by mass of bis(2-mercaptoethyl)sulfide [dithiol compound (c1)] and 248.6 parts by mass of 4-mercaptomethyl-1,8-dimercapto-3,6-dithiaoctane[polythiol compound (c2)] were added to, mixed with, and dissolved in the solution to obtain a uniform solution.

The uniform solution was defoamed at 400 Pa and then injected into a molding mold through a 1 m filter. This was put into a polymerization oven, and the temperature was gradually raised from 15° C. to 120° C. over 56 hours to perform polymerization and curing.

After completion of the polymerization, the cured product was taken out from the oven, released from the molding mold, and further subjected to an annealing treatment at 120° C. for 1 hour to obtain a molded body.

The physical property values of the obtained molded body are shown in Table 5.

### Example 202

A mixture (50.77 parts by mass) of 2,5-bis(isocyanatomethyl)bicyclo[2.2.1]heptane and 2,6-bis(isocyanatomethyl)bicyclo[2.2.1]heptane was added to 0.60 parts by mass of Eversorb109, 0.06 parts by mass of dibutyltin dichloride, 0.05 parts by mass of 3,5-lutidine, and 0.60 parts by mass of an internal mold release agent (manufactured by Johoku Chemical Co., Ltd.; trade name: JP-506H), and they were mixed for dissolution to obtain a uniform solution.

Further, 72.75 parts by mass of the iso(thio)cyanate compound-containing solution described in Example 201 was added to the solution, and they were mixed for dissolution to obtain a uniform solution.

Next, 51.62 parts by mass of bis(2-mercaptoethyl)sulfide [dithiol compound (c1)] and 24.86 parts by mass of 4-mercaptomethyl-1,8-dimercapto-3,6-dithiaoctane[polythiol compound (c2)] were added to, mixed with, and dissolved in the solution to obtain a uniform solution.

The uniform solution was defoamed at 400 Pa and then injected into a molding mold through a 1 m filter. This was put into a polymerization oven, and the temperature was gradually raised from 15° C. to 120° C. over 47 hours to perform polymerization and curing.

After completion of the polymerization, the cured product was taken out from the oven, released from the molding mold, and further subjected to an annealing treatment at 120° C. for 1 hour to obtain a molded body.

The physical property values of the obtained molded body are shown in Table 5.

### Example 203

A molded body was obtained in the same manner as in Example 202 except that the content of Eversorb 109 was changed to 1.0 part by mass.

The physical property values of the obtained molded body are shown in Table 5.

### Example 204

A molded body was obtained in the same manner as in Example 202 except that the content of Eversorb 109 was changed to 2.0 parts by mass.

The physical property values of the obtained molded body are shown in Table 5.

TABLE 5

| | | Example 201 | Example 202 | Example 203 | Example 204 |
|---|---|---|---|---|---|
| DBC [ppm] | | 300 | 300 | 300 | 300 |
| 3,5-Lutidine [ppm] | | 250 | 250 | 250 | 250 |
| Ultraviolet | Type | Eversorb 109 | Eversorb 109 | Eversorb 109 | Eversorb 109 |
| absorber | Addition amount | 0.2 | 0.3 | 0.5 | 1 |
| | [mass %] | | | | |

| | | | | |
|---|---|---|---|---|
| Heat resistance (Tg) [° C.] | 89 | 87 | 87 | 87 |
| Heat resistance evaluation | A | A | A | A |
| Haze | 0.12 | 0.30 | 0.38 | 0.20 |
| 400 nm cut rate [%] | 93.6 | 97.8 | 99.7 | 100 |
| 400 nm cut rate evaluation | A | A | A | A |
| Impact resistance test | A | — | — | — |

As shown in Table 5, it was possible to obtain a cured product excellent in light blocking properties against light having a wavelength of 400 nm while maintaining impact resistance and heat resistance, in the Examples each using the polymerizable composition for an optical material containing the amine compound (A), the iso(thio)cyanate compound (B), the polythiol compound (C), and the ultraviolet absorber (F) having a maximum absorption peak in a range of from 350 nm to 370 nm and including a compound represented by the following general formula (6).

The Examples employed the iso(thio)cyanate compound that is a reaction product between the amine compound (A) including at least one selected from the compound (a1) represented by general formula (1) or the compound (a2) represented by general formula (2) and the bi- or higher-functional iso(thio)cyanate compound (B), the iso(thio)cyanate compound having a value of Mw/Mn of 1.14, the value of Mw/Mn being the weight average molecular weight (Mw) divided by the number average molecular weight (Mn).

On the other hand, in Comparative Examples 201 to 204 in which the ultraviolet absorber (F) in the third embodiment was not contained, cured products having excellent light blocking properties against light having a wavelength of 400 nm could not be obtained.

The disclosures of Japanese Patent Application No. 2020-216938 filed on Dec. 25, 2020, Japanese Patent Application No. 2021-017452 filed on Feb. 5, 2021, and Japanese Patent Application No. 2021-017453 filed on Feb. 5, 2021 are incorporated herein by reference in their entirety.

All documents, patent applications, and technical standards described herein are incorporated herein by reference to the same extent as if each document, patent application, and technical standard are specifically and individually indicated to be incorporated by reference.

1. An iso(thio)cyanate compound that is a reaction product between an amine compound (A) comprising at least one selected from a compound (a1) represented by the following general formula (1) or a compound (a2) represented by the following general formula (2), and a bi- or higher-functional iso(thio)cyanate compound (B),
the iso(thio)cyanate compound having a value of Mw/Mn of 1.31 or less, the value of Mw/Mn being a weight average molecular weight (Mw) divided by a number average molecular weight (Mn): 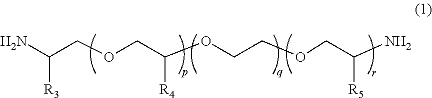
wherein, in the general formula (1), each of R₃ to R₅ independently represents a hydrogen atom or a methyl group; p represents an integer from 0 to 100; q represents an integer from 0 to 100; r represents an integer from 0 to 100; p+r equals an integer from 1 to 100; when a plurality of R₄ is present, respective R₄'s may be the same as or different from each other; and when a plurality of R₅ is present, respective R₅'s may be the same as or different from each other: 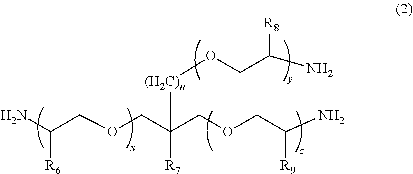
wherein, in the general formula (2), each of R₆, R₈, and R₉ independently represents a hydrogen atom or a methyl group; R₇ represents a linear alkyl group having 1 to 20 carbon atoms, a branched alkyl group having 3 to 20 carbon atoms, or a cyclic alkyl group having 3 to 20 carbon atoms; x represents an integer from 0 to 200; y represents an integer from 0 to 200; z represents an integer from 0 to 200; x+y+z equals an integer from 1 to 200; n represents an integer from 0 to 10; when a plurality of R₆ is present, respective R₆'s may be the same as or different from each other; when a plurality of R₈ is present, respective R₈'s may be the same as or different from each other; and when a plurality of R₉ is present, respective R₉'s may be the same as or different from each other.

2. The iso(thio)cyanate compound according to claim 1, wherein a ratio (a/b) of a number of moles a of an amino group in the amine compound (A) to a number of moles b of an iso(thio)cyanato group in the iso(thio)cyanate compound (B) is less than 1.0.

3. The iso(thio)cyanate compound according to claim 1, wherein the amine compound (A) comprises the compound (a1) represented by the general formula (1), and a weight average molecular weight (Mw) of the compound (a1) represented by the general formula (1) is from 100 to 4000.

4. The iso(thio)cyanate compound according to claim 1, wherein the amine compound (A) comprises the compound (a2) represented by the general formula (2), and a weight average molecular weight (Mw) of the compound (a2) represented by the general formula (2) is from 100 to 5000.

5. The iso(thio)cyanate compound according to claim 1, wherein the iso(thio)cyanate compound (B) is at least one selected from the group consisting of hexamethylene diisocyanate, pentamethylene diisocyanate, xylylene diisocyanate, isophorone diisocyanate, bis(isocyanatomethyl)cyclohexane, dicyclohexylmethane-4,4′-diisocyanate, 2,5-bis(isocyanatomethyl)bicyclo-[2.2.1]-heptane, 2,6-bis(isocyanatomethyl)bicyclo-[2.2.1]-heptane, tolylene diisocyanate, phenylene diisocyanate, and 4,4′-diphenylmethane diisocyanate.

6. A polymerizable composition for an optical material, the polymerizable composition comprising the iso(thio)cyanate compound according to claim 1.

7. The polymerizable composition for an optical material according to claim 6, further comprising the iso(thio)cyanate compound (B).

8. The polymerizable composition for an optical material according to claim 6, further comprising a thiol compound (C) comprising at least one of a dithiol compound (c1) having two mercapto groups or a polythiol compound (c2) having three or more mercapto groups.

9. The polymerizable composition for an optical material according to claim 8, wherein the thiol compound (C) comprises both the dithiol compound (c1) and the polythiol compound (c2), and a ratio (c1/c2) of a number of moles c1 of the mercapto groups of the dithiol compound (c1) to a number of moles c2 of the mercapto groups in the polythiol compound (c2) is in a range of from 1 to 13.

10. The polymerizable composition for an optical material according to claim 8, wherein:
the dithiol compound (c1) is at least one selected from the group consisting of 2,5-dimercaptomethyl-1,4-dithiane, ethylene glycol bis(3-mercaptopropionate), 4,6-bis(mercaptomethylthio)-1,3-dithiane, 2-(2,2-bis(mercaptomethylthio)ethyl)-1,3-dithietane, and bis(2-mercaptoethyl)sulfide, and
the polythiol compound (c2) is at least one selected from the group consisting of trimethylolpropane tris(3-mercaptopropionate), pentaerythritol tetrakis(2-mercaptoacetate), pentaerythritol tetrakis(3-mercaptopropionate), 4-mercaptomethyl-1,8-dimercapto-3,6-dithiaoctane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, and 1,1,3,3-tetrakis(mercaptomethylthio)propane.

11. The polymerizable composition for an optical material according to claim 6, further comprising an organotin compound (D) and a tertiary amine compound (E).

12. The polymerizable composition for an optical material according to claim 6, further comprising an ultraviolet absorber (F) having a maximum absorption peak in a range of from 350 nm to 370 nm and including a compound represented by the following general formula (6): 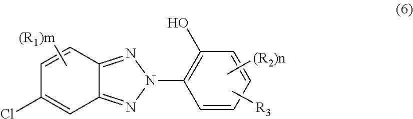
wherein, in the general formula (6), each of R₁ and R₂ independently represents an alkyl group having 1 to 8 carbon atoms; when a plurality of R₁ is present, respective R₁'s may be the same as or different from each other; when a plurality of R₂ is present, respective R₂'s may be the same as or different from each other; R₃ represents a functional group having 2 to 15 carbon atoms and containing an ester bond; m represents an integer from 0 to 3; and n represents an integer from 0 to 3.

13. A molded body, obtained by curing the polymerizable composition for an optical material according to claim 6.

14. An optical material, comprising the molded body according to claim 13.

15. A plastic lens, comprising the molded body according to claim 13.

16. A plastic polarizing lens, comprising:
a substrate layer comprising the molded body according to claim 13; and
a polarizing film.

17. An iso(thio)cyanate compound production method for producing the iso(thio)cyanate compound according to claim 1, the method comprising:
producing the iso(thio)cyanate compound by reacting the amine compound (A) with the iso(thio)cyanate compound (B) under a condition that satisfies at least one of the following condition 1 or condition 2:
Condition 1: a mixture of the amine compound (A) and the iso(thio)cyanate compound (B) is reacted by stirring at a stirring rate of 150 rpm to 200 rpm, and the amine compound (A) and the iso(thio)cyanate compound (B) are reacted in a reaction device in which a ratio (D/d) of a reactor diameter (D) to a stirring blade diameter (d) is 3.0 or less,
Condition 2: a mixture of the amine compound (A) and the iso(thio)cyanate compound (B) is reacted by stirring at a stirring rate of 200 rpm or more.

18. A method for producing a polymerizable composition for an optical material, the method comprising:
producing an iso(thio)cyanate compound by the iso(thio)cyanate compound production method according to claim 17; and
mixing the iso(thio)cyanate compound with a thiol compound (C) comprising at least one of a dithiol compound (c1) having two mercapto groups or a polythiol compound (c2) having three or more mercapto groups to produce a composition.

19. A method for producing an optical material, the method comprising:
injecting the polymerizable composition for an optical material according to claim 6 into a mold; and
polymerizing and curing the polymerizable composition for an optical material in the mold.

20. A method for producing a plastic polarizing lens, the method comprising:
disposing a polarizing film in a mold;
injecting the polymerizable composition for an optical material according to claim 6 into the mold in which the polarizing film is disposed; and
polymerizing and curing the polymerizable composition for an optical material to obtain a plastic polarizing lens comprising: a substrate layer comprising a molded body obtained by curing the polymerizable composition for an optical material; and a polarizing film.
